(19) United States
(12) Patent Application Publication
(10) Pub. No.: US 2024/0264290 A1
(43) Pub. Date: Aug. 8, 2024

(54) SYSTEMS AND METHODS FOR LIDAR SCAN RATE CONTROL

(71) Applicant: VELODYNE LIDAR USA, INC., San Jose, CA (US)

(72) Inventor: Mattias Philip Ingvar Payne, Santa Cruz, CA (US)

(21) Appl. No.: 18/421,562

(22) Filed: Jan. 24, 2024

Related U.S. Application Data
(60) Provisional application No. 63/443,865, filed on Feb. 7, 2023.

(51) Int. Cl. G01S 7/4913; G01S 7/497; G01S 17/32

(52) U.S. Cl. CPC G01S 7/4913; G01S 7/497; G01S 17/32

(57) ABSTRACT

Methods and systems for controlling a lidar device are disclosed. One example method includes determining a horizontal scan period P_{H} for a lidar device. The method further includes determining a vertical swipe duration Dₛ for the lidar device based on (i) the horizontal scan period P_{H} and (ii) a target frame duration D_{f} for the lidar device. The method further includes determining a dead time D_{d} for the lidar device based on the vertical swipe duration Dₛ, the horizontal scan period P_{H}, and the target frame duration D_{f}. The method further includes controlling the lidar device to scan an environment according to the vertical swipe duration Dₛ and the dead time D_{d}.

### CROSS-REFERENCES TO RELATED APPLICATIONS

The application claims benefit of U.S. Provisional Application No. 63/443,865, filed Feb. 7, 2023, the entire contents of which is hereby incorporated by reference for all purposes.

### FIELD OF TECHNOLOGY

The present disclosure relates generally to lidar technology and, more specifically, to systems and methods for controlling a lidar scan rate.

### BACKGROUND

Lidar (light detection and ranging) systems measure the attributes of their surrounding environments (e.g., shape of a target, contour of a target, distance to a target, etc.) by illuminating the environment with light (e.g., laser light) and measuring the reflected light with sensors. Differences in laser return times and/or wavelengths can then be used to make digital, three-dimensional (“3D”) representations of a surrounding environment. Lidar technology may be used in various applications including autonomous vehicles, advanced driver assistance systems, mapping, security, surveying, robotics, geology and soil science, agriculture, unmanned aerial vehicles, airborne obstacle detection (e.g., obstacle detection systems for aircraft), etc. Depending on the application and associated field of view, multiple optical transmitters and/or optical receivers may be used to produce images in a desired resolution. A lidar system with greater numbers of transmitters and/or receivers can generally generate larger numbers of pixels.

In a multi-channel lidar device, optical transmitters can be paired with optical receivers to form multiple “channels.” In operation, each channel's transmitter can emit an optical signal (e.g., laser light) into the device's environment, and the channel's receiver can detect the portion of the signal that is reflected back to the channel's receiver by the surrounding environment. In this way, each channel can provide “point” measurements of the environment, which can be aggregated with the point measurements provided by the other channel(s) to form a “point cloud” of measurements of the environment.

The measurements collected by a lidar channel may be used to determine the distance (“range”) from the device to the surface in the environment that reflected the channel's transmitted optical signal back to the channel's receiver. In some cases, the range to a surface may be determined based on the time of flight of the channel's signal (e.g., the time elapsed from the transmitter's emission of the optical signal to the receiver's reception of the return signal reflected by the surface). In other cases, the range may be determined based on the wavelength (or frequency) of the return signal(s) reflected by the surface.

In some cases, lidar measurements may be used to determine the reflectance of the surface that reflects an optical signal. The reflectance of a surface may be determined based on the intensity of the return signal, which generally depends not only on the reflectance of the surface but also on the range to the surface, the emitted signal's glancing angle with respect to the surface, the power level of the channel's transmitter, the alignment of the channel's transmitter and receiver, and other factors.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

In various examples, the subject matter of this disclosure relates to devices, systems, and methods for controlling a lidar device. In one aspect, according to some embodiments, a lidar method is disclosed. The method includes determining a horizontal scan period P_{H} for a lidar device. The method further includes determining a vertical swipe duration Dₛ for the lidar device based on (i) the horizontal scan period P_{H} and (ii) a target frame duration D_{f} for the lidar device. The method further includes determining a dead time D_{d} for the lidar device based on the vertical swipe duration Dₛ, the horizontal scan period P_{H}, and the target frame duration D_{f}. The method further includes controlling the lidar device to scan an environment according to the vertical swipe duration Dₛ and the dead time D_{d}.

In another aspect, according to some embodiments, a lidar system is disclosed. The lidar system includes a lidar device, and at least one computer processor programmed to perform operations including: determining a horizontal scan period P_{H} for a lidar device; determining a vertical swipe duration Dₛ for the lidar device based on (i) the horizontal scan period P_{H} and (ii) a target frame duration D_{f} for the lidar device; determining a dead time D_{d} for the lidar device based on the vertical swipe duration Dₛ, the horizontal scan period P_{H}, and the target frame duration D_{f}; and controlling the lidar device to scan an environment according to the vertical swipe duration Dₛ and the dead time D_{d}.

In another aspect, according to some embodiments, a computer program product for controlling a lidar device is disclosed. The computer program product includes a non-transitory computer-readable medium having computer readable program code stored thereon. The computer readable program code is configured to: determine a horizontal scan period P_{H} for a lidar device; determine a vertical swipe duration Dₛ for the lidar device based on (i) the horizontal scan period P_{H} and (ii) a target frame duration D_{f} for the lidar device; determine a dead time D_{d} for the lidar device based on the vertical swipe duration Dₛ, the horizontal scan period P_{H}, and the target frame duration D_{f}, and control the lidar device to scan an environment according to the vertical swipe duration Dₛ and the dead time D_{d}.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is an illustration of an exemplary lidar system, in accordance with some embodiments.

FIG. 2A is an illustration of the operation of a lidar system, in accordance with some embodiments.

FIG. 2B is an illustration of optical components of a channel of a lidar system with a movable mirror, in accordance with some embodiments.

FIG. 2C is an illustration of an example of a 3D lidar system, in accordance with some embodiments.

FIG. 2D is a block diagram of a transmitter-receiver optical sub-assembly (TROSA), according to some embodiments.

FIG. 3A is an illustration of a distributed sensor system installed in an automobile utilizing a suite of sensors coupled to a microcontroller (MCU), in accordance with some embodiments.

FIG. 3B is an illustration of a framework for a sensor system, in accordance with some embodiments.

FIG. 4A is a schematic diagram of a field of view from a perspective of a lidar device, in accordance with some embodiments.

FIG. 4B is a plot of a horizontal scan profile for a lidar device, in accordance with some embodiments.

FIG. 4C is a plot of a vertical scan profile for a lidar device, in accordance with some embodiments.

FIG. 5 is a plot of a horizontal scan profile superimposed over a vertical scan profile, in accordance with some embodiments.

FIG. 6 is a plot of a horizontal scan profile superimposed over a vertical scan profile, in accordance with some embodiments.

FIG. 7 is an illustration of function modules included in a firmware or control algorithm for a dual-axis scanner, in accordance with some embodiments.

FIG. 8 is a flow chart of an example method for controlling a dual-axis scanner, in accordance with some embodiments.

FIG. 9A is an illustration of an example architecture for controlling a dual-axis scanner, in accordance with some embodiments.

FIG. 9B is an illustration of another example architecture for controlling a dual-axis scanner, in accordance with some embodiments.

FIG. 10 is an illustration of an example scan pattern produced by a lidar system with a dual-axis scanner, in accordance with some embodiments.

FIG. 11 is an illustration of an example continuous wave (CW) coherent lidar system, in accordance with some embodiments.

FIG. 12 is an illustration of an example frequency modulated continuous wave (FMCW) coherent lidar system, in accordance with some embodiments.

FIG. 13A is a plot of a frequency chirp as a function of time in a transmitted laser signal and reflected signal, in accordance with some embodiments.

FIG. 13B is a plot illustrating a beat frequency of a mixed signal, in accordance with some embodiments.

FIG. 14 is a block diagram of a silicon photonic integrated circuit (PIC) in accordance with some embodiments.

FIG. 15 is a block diagram of an example computer system, in accordance with some embodiments.

FIG. 16 is a block diagram of a computing device/information handling system, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

The disclosure relates to constant framerate control for dual-axis scanners. It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

Three of the most significant technical challenges faced by the lidar industry are (1) reducing the manufacturing cost for lidar devices while maintaining existing performance levels, (2) improving the reliability of lidar devices under automotive operating conditions (e.g., weather, temperature, and mechanical vibration), and (3) increasing the range of lidar devices. One approach to reducing manufacturing costs is to reduce the amount of hardware (e.g., channels, transmitters, emitters, receivers, detectors, etc.) in the lidar device while increasing the utilization of the remaining hardware to maintain performance levels. One approach to improving device reliability is to develop lidar devices that use fewer moving mechanical parts (e.g., by eliminating or simplifying mechanical beam scanners). One approach to extending range is to develop lidar devices that use solid-state lasers.

### Motivation for and Benefits of Some Embodiments

In general, it can be desirable to control a rate at which a lidar device scans a surrounding environment. For example, the lidar device may be incorporated into a sensor system that includes a camera (or other sensors), and it can be desirable to make the scan rate of the lidar device consistent with the framerate of the camera. It can be easier, for example, to process data collected by the sensor system when the lidar device and the camera collect and/or output data at the same rate.

Certain lidar devices (e.g., dual-axis lidar devices) may have a component (e.g., a mirror) that oscillates at a resonant frequency when performing a scan. Due to variations in operating conditions (e.g., temperature) and/or manufacturing tolerances, the resonant frequency can change over time and/or can be inconsistent from one lidar device to the next. Such changes in the resonant frequency can make it difficult to achieve a constant or desired lidar scan rate, which can make it challenging to synchronize a lidar device with other sensors and/or to integrate the lidar device into a multi-sensor system.

Previous approaches for addressing lidar scan rate variations can involve adjusting a scan pattern or a vertical field of view. For example, in some instances, a user can obtain a consistent lidar scan rate by varying the scan pattern (e.g., point cloud locations) or the vertical field of view over successive scans; however, it is generally preferable to keep the scan pattern and the vertical field of view constant (e.g., to provide consistent data from scan to scan).

Advantageously, the technical solution disclosed herein allows a lidar device (or other dual-axis scanners) to scan at a desired, constant rate, without having to adjust the scan pattern or vertical field of view. The technical solution is able to achieve the desired, constant scan rate despite variations that may occur in the resonant frequency due to changes in temperature or other operating conditions. Further, the technical solution can allow the lidar scan rate to be synchronized with the framerate of a camera or other sensor in a sensor system (e.g., using an external trigger). Additional advantages and benefits of the technical solution will become apparent in view of the examples described herein.

### Some Examples of Lidar Systems

A lidar system may be used to measure the shape and contour of the environment surrounding the system. Lidar systems may be applied to numerous applications including autonomous navigation and aerial mapping of surfaces. In general, a lidar system emits light that is subsequently reflected by objects within the environment in which the system operates. The light may be emitted by a laser (e.g., a rapidly firing laser). Laser light travels through a medium and reflects off points of surfaces in the environment (e.g., surfaces of buildings, tree branches, vehicles, etc.). The reflected (and/or scattered) light energy returns to a lidar detector where it may be sensed and used to perceive the environment.

The science of lidar systems is based on the physics of light and optics. Any suitable measurement techniques may be used to determine the attributes of objects in a lidar system's environment. In some examples, the lidar system is configured to emit light pulses (e.g., individual pulses or sequences of pulses). The time each pulse (or pulse sequence) travels from being emitted to being received (“time of flight” or “TOF”) may be measured to determine the distance between the lidar system and the object that reflects the pulse. Lidar systems that operate in this way may be referred to as “pulsed lidar,” “TOF lidar,” “direct TOF lidar,” or “pulsed TOF lidar.” In some other examples, the time of flight may be calculated indirectly (e.g., using amplitude-modulated continuous wave (AMCW) structured light). Lidar systems that operate in this way may be referred to as “indirect TOF lidar” or “iTOF lidar.” In still other examples, the lidar system can be configured to emit continuous wave (CW) light. The wavelength (or frequency) of the received, reflected light may be measured to determine the distance between the lidar system and the object that reflects the light. In some examples, lidar systems can measure the speed (or velocity) of objects. Lidar systems that operate in this way may be referred to as “coherent lidar,” “continuous wave lidar,” or “CW lidar.” In a CW lidar system, any suitable variant of CW lidar sensing may be used. For example, frequency modulated continuous wave (FMCW) lidar sensing may be used.

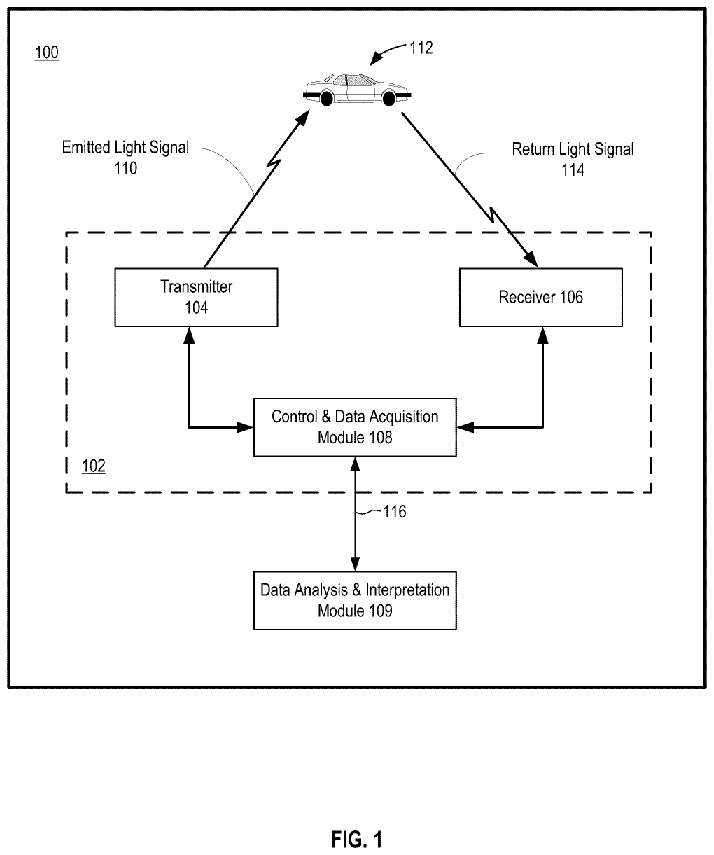

FIG. 1 depicts the operation of a lidar system 100, according to some embodiments. In the example of FIG. 1, the lidar system 100 includes a lidar device 102, which may include a transmitter 104 that generates and emits a light signal 110, a receiver 106 that detects and processes a return light signal 114, and a control & data acquisition module 108. The transmitter 104 may include a light source (e.g., “optical emitter” or “emitter”), electrical components operable to activate (e.g., drive) and deactivate the light source in response to electrical control signals, and optical components adapted to shape and redirect the light emitted by the light source. The receiver 106 may include a light detector (e.g., “optical detector,” “photodetector,” or “detector”) and optical components adapted to shape return light signals 114 and direct those signals to the detector. In some implementations, one or more optical components (e.g., lenses, mirrors, etc.) may be shared by the transmitter and the receiver.

The lidar device 102 may be referred to as a lidar transceiver or “channel.” In operation, the emitted light signal 110 propagates through a medium and reflects off an object(s) 112, whereby a return light signal 114 propagates through the medium and is received by receiver 106. In one example, each lidar channel may correspond to a physical mapping of a single emitter to a single detector (e.g., a one-to-one pairing of a particular emitter and a particular detector). In other examples, however, each lidar channel may correspond to a physical mapping of multiple emitters to a single detector or a physical mapping of a single emitter to multiple detectors (e.g., a “flash” configuration). In some examples, a lidar system 100 may have no fixed channels; rather, light emitted by one or more emitters may be detected by one or more detectors without any physical or persistent mapping of specific emitters to specific detectors.

Any suitable light source may be used including, without limitation, one or more gas lasers, chemical lasers, metal-vapor lasers, solid-state lasers (SSLs) (e.g., Q-switched SSLs, Q-switched solid-state bulk lasers, etc.), fiber lasers (e.g., Q-switched fiber lasers), liquid lasers (e.g., dye lasers), semiconductor lasers (e.g., laser diodes, edge emitting lasers (EELs), vertical-cavity surface emitting lasers (VCSELs), quantum cascade lasers, quantum dot lasers, quantum well lasers, hybrid silicon lasers, optically pumped semiconductor lasers, etc.), and/or any other device operable to emit light. For semiconductor lasers, any suitable gain medium may be used including, without limitation, gallium nitride (GaN), indium gallium nitride (InGaN), aluminum gallium indium phosphide (AlGaInP), aluminum gallium arsenide (AlGaAs), indium gallium arsenide phosphide (InGaAsP), lead salt, etc. For Q-switched lasers, any suitable type or variant of Q-switching can be used including, without limitation, active Q-switching, passive Q-switching, cavity dumping, regenerative Q-switching, etc. The light source may emit light having any suitable wavelength or wavelengths, including but not limited to wavelengths between 100 nm (or less) and 1 mm (or more). Semiconductor lasers operable to emit light having wavelengths of approximately 905 nm, 1300 nm, or 1550 nm are widely commercially available. In some examples, the light source may be operated as a pulsed laser, a continuous-wave (CW) laser, and/or a coherent laser. A light signal (e.g., “optical signal”) 110 emitted by a light source may consist of a single pulse, may include a sequence of two or more pulses, or may be a continuous wave.

A lidar system 100 may use any suitable illumination technique to illuminate the system's field of view (FOV). In some examples, the lidar system 100 may illuminate the entire FOV simultaneously. Such illumination techniques may be referred to herein as “flood illumination” or “flash illumination.” In some examples, the lidar system 100 may illuminate fixed, discrete spots throughout the FOV simultaneously. Such illumination techniques may be referred to herein as “fixed spot illumination.” In some examples, the lidar system 100 may illuminate a line within the FOV and use a scanner (e.g., a 1D scanner) to scan the line over the entire FOV. Such illumination techniques may be referred to herein as “scanned line illumination.” In some examples, the lidar system 100 may simultaneously illuminate one or more spots within the FOV and use a scanner (e.g., a 1D or 2D scanner) to scan the spots over the entire FOV. Such illumination techniques may be referred to herein as “scanned spot illumination.”

Any suitable optical detector may be used including, without limitation, one or more photodetectors, contact image sensors (CIS), solid-state photodetectors (e.g., photodiodes (PD), single-photon avalanche diode (SPADs), avalanche photodiodes (APDs), etc.), photomultipliers (e.g., silicon photomultipliers (SiPMs), and/or any other device operable to convert light (e.g., optical signals) into electrical signals. In some examples, CIS can be fabricated using a complementary metal-oxide semiconductor (CMOS) process. In some examples, solid-state photodetectors can be fabricated using semiconductor processes similar to CMOS. Such semiconductor processes may use silicon, germanium, indium gallium arsenide, lead (II) sulfide, mercury cadmium, telluride, MoS₂, graphene, and/or any other suitable material(s). In some examples, an array of integrated or discrete CIS or solid-state photodetectors can be used to simultaneously image (e.g., perform optical detection across) the lidar device's entire field of view or a portion thereof. In general, solid-state photodetectors may be configured to detect light having wavelengths between 190 nm (or lower) and 1.4 μm (or higher). PDs and APDs configured to detect light having wavelengths of approximately 905 nm, 1300 nm, or 1550 nm are widely commercially available.

The lidar system 100 may include any suitable combination of measurement technique(s), light source(s), illumination technique(s), and detector(s). Some combinations may be more accurate or more economical under certain conditions. For example, some combinations may be more economical for short-range sensing but incapable of providing accurate measurements at longer ranges. Some combinations may pose potential hazards to eye safety, while other combinations may reduce such hazards to negligible levels.

The control & data acquisition module 108 may control the light emission by the transmitter 104 and may record data derived from the return light signal 114 detected by the receiver 106. In some embodiments, the control & data acquisition module 108 controls the power level at which the transmitter 104 operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 or the receiver 106 determines (e.g., measures) particular characteristics of the return light signal 114 detected by the receiver 106. For example, the control & data acquisition module 108 or receiver 106 may measure the intensity of the return light signal 114 using any suitable technique.

Operational parameters of the transceiver 102 may include its horizontal field of view (“FOV”) and its vertical FOV. The FOV parameters effectively define the region of the environment that is visible to the specific lidar transceiver 102. More generally, the horizontal and vertical FOVs of a lidar system 100 may be defined by combining the fields of view of a plurality of lidar devices 102.

To obtain measurements of points in its environment and generate a point cloud based on those measurements, a lidar system 100 may scan its FOV. A lidar transceiver system 100 may include one or more beam-steering components (not shown) to redirect and shape the emitted light signals 110 and/or the return light signals 114. Any suitable beam-steering components may be used including, without limitation, mechanical beam steering components (e.g., rotating assemblies that physically rotate the transceiver(s) 102, rotating scan mirrors that deflect emitted light signals 110 and/or return light signals 114, etc.), optical beam steering components (e.g., lenses, lens arrays, microlenses, microlens arrays, beam splitters, etc.), microelectromechanical (MEMS) beam steering components (e.g., MEMS scan mirrors, etc.), solid-state beam steering components (e.g., optical phased arrays, optical frequency diversity arrays, etc.), etc.

In some implementations, the lidar system 100 may include or be communicatively coupled to a data analysis & interpretation module 109, which may receive outputs (e.g., via a connection 116) from the control & data acquisition module 108 and may perform data analysis on those outputs. By way of example and not limitation, connection 116 may be implemented using wired or wireless (e.g., non-contact communication) technique(s).

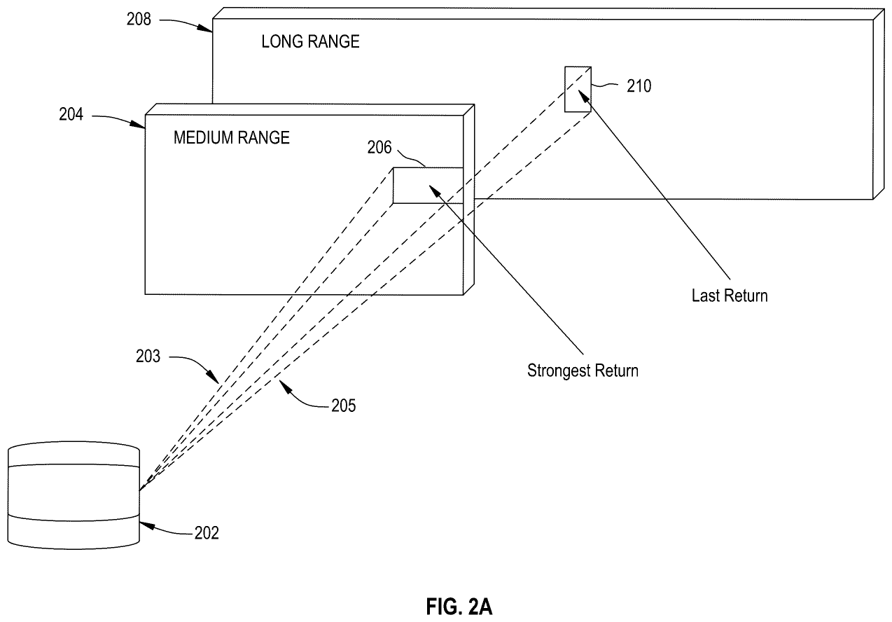

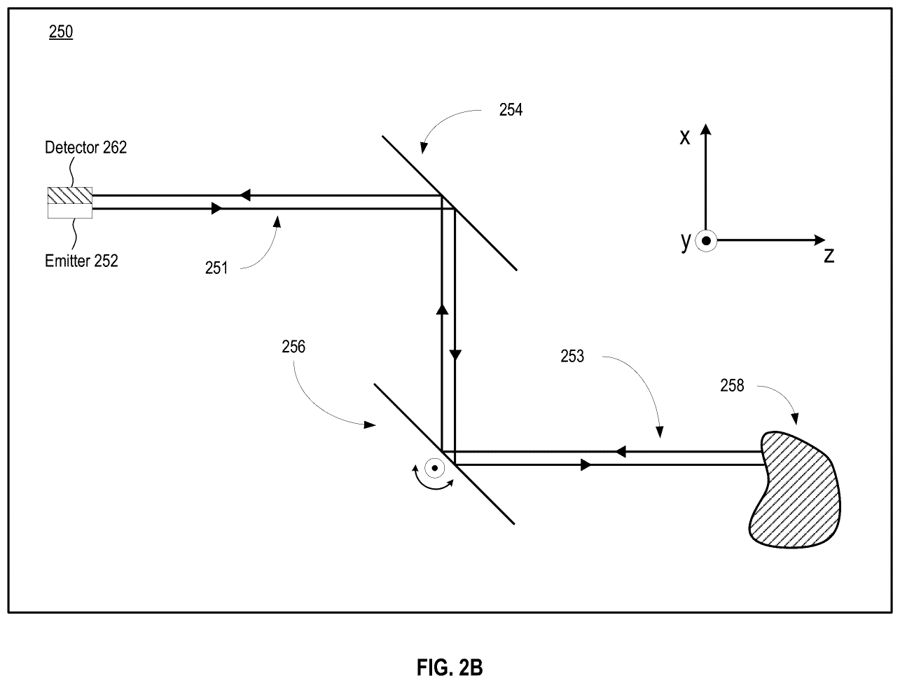

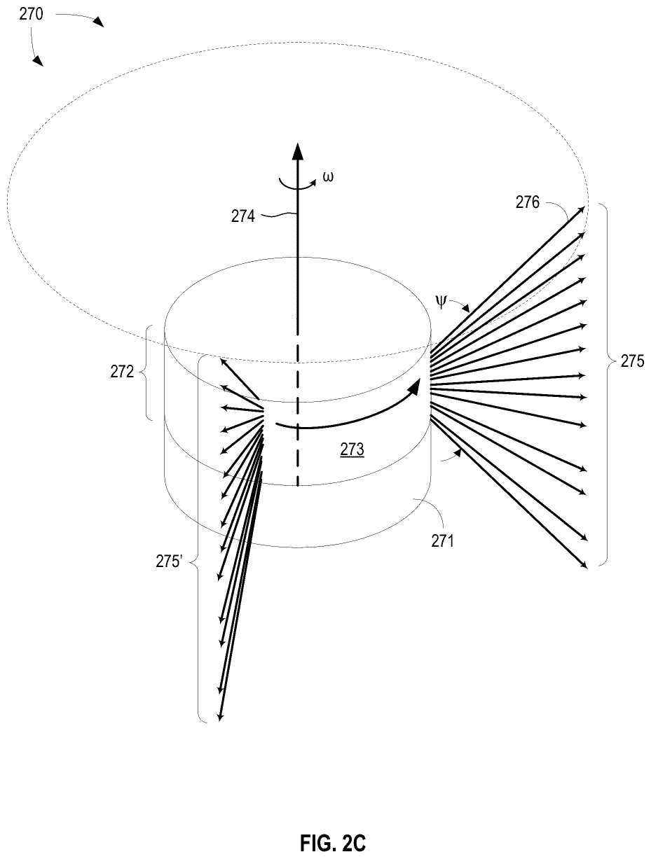

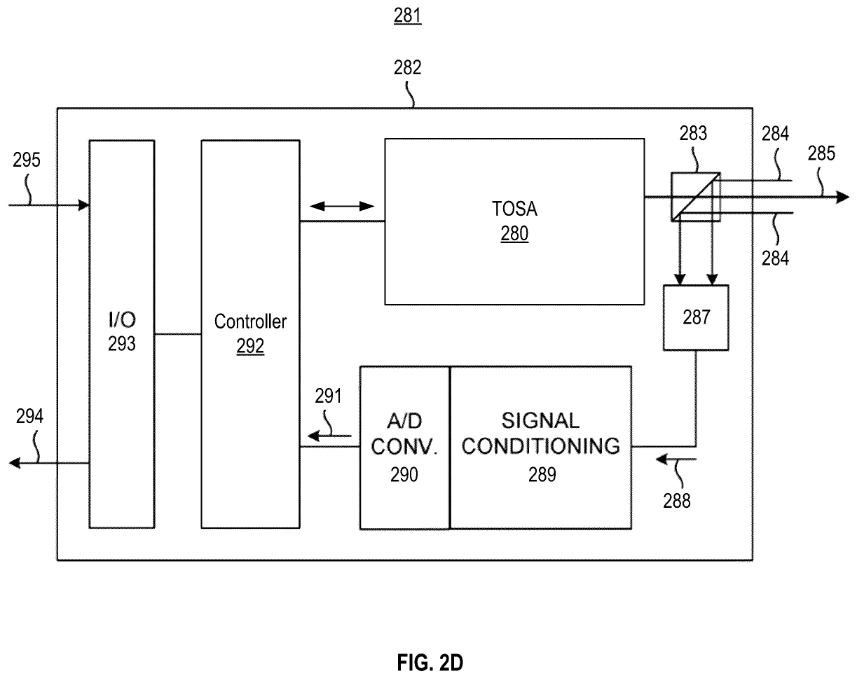

FIG. 2A illustrates the operation of a lidar system 202, in accordance with some embodiments. In the example of FIG. 2A, two return light signals 203 and 205 are shown. Because laser beams generally tend to diverge as they travel through a medium, a single laser emission may hit multiple objects at different ranges from the lidar system 202, producing multiple return signals 203, 205. The lidar system 202 may analyze multiple return signals 203, 205 and report one of the return signals (e.g., the strongest return signal, the last return signal, etc.) or more than one (e.g., all) of the return signals. In the example of FIG. 2A, lidar system 202 emits laser light in the direction of near wall 204 and far wall 208. As illustrated, the majority of the emitted light hits the near wall 204 at area 206 resulting in a return signal 203, and another portion of the emitted light hits the far wall 208 at area 210 resulting in a return signal 205. Return signal 203 may have a shorter TOF and stronger received signal strength compared to return signal 205. In both single- and multiple-return lidar systems, it is important that each return signal is accurately associated with the transmitted light signal so that one or more attributes of the object reflecting the light signal (e.g., range, velocity, reflectance, etc.) can be correctly estimated.

Some embodiments of a lidar system may capture distance data in a two-dimensional (“2D”) (e.g., within a single plane) point cloud manner. These lidar systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., to the detector). Use of a movable (e.g., oscillating) mirror in this manner may enable the lidar system to achieve 90-180-360 degrees of azimuth (horizontal) view while simplifying both the system design and manufacturability. Many applications require more data than just a 2D plane. The 2D point cloud may be expanded to form a 3D point cloud, in which multiple 2D point clouds are used, each corresponding to a different elevation (e.g., a different position and/or direction with respect to a vertical axis). Operational parameters of the receiver of a lidar system may include the horizontal FOV and the vertical FOV.

FIG. 2B depicts a lidar system 250 with a movable (e.g., rotating or oscillating) mirror, according to some embodiments. In the example of FIG. 2B, the lidar system 250 uses a single emitter 252/detector 262 pair combined with a fixed mirror 254 and a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The emitted laser signal 251 may be directed to a fixed mirror 254, which may reflect the emitted laser signal 251 to the movable mirror 256. As movable mirror 256 moves (e.g., oscillates), the emitted laser signal 251 may reflect off an object 258 in its propagation path. The reflected return signal 253 may be coupled to the detector 262 via the movable mirror 256 and the fixed mirror 254. In some embodiments, the movable mirror 256 is implemented with mechanical technology or with solid state technology (e.g., MEMS).

FIG. 2C depicts a 3D lidar system 270, according to some embodiments. In the example of FIG. 2C, the 3D lidar system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D lidar system 270 includes a lidar transceiver, such as transceiver 102 shown in FIG. 1, operable to emit laser beams 276 through the cylindrical shell element 273 of the upper housing 272. In the example of FIG. 2C, each individual arrow in the sets of arrows 275, 275′ directed outward from the 3D lidar system 270 represents a laser beam 276 emitted by the 3D lidar system. Each beam of light emitted from the system 270 (e.g., each laser beam 276) may diverge slightly, such that each beam of emitted light forms a cone of light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D lidar system 270. The direction of each emitted beam may be determined by the angular orientation w of the transceiver's transmitter 104 with respect to the system's central axis 274 and by the angular orientation y of the transmitter's movable mirror (e.g., similar or identical to movable mirror 256 shown in FIG. 2B) with respect to the mirror's axis of oscillation (or rotation). For example, the direction of an emitted beam in a horizontal dimension may be determined by the transmitter's angular orientation w, and the direction of the emitted beam in a vertical dimension may be determined by the angular orientation y of the transmitter's movable mirror. Alternatively, the direction of an emitted beam in a vertical dimension may be determined by the transmitter's angular orientation w, and the direction of the emitted beam in a horizontal dimension may be determined by the angular orientation y of the transmitter's movable mirror. (For purposes of illustration, the beams of light 275 are illustrated in one angular orientation relative to a non-rotating coordinate frame of the 3D lidar system 270 and the beams of light 275′ are illustrated in another angular orientation relative to the non-rotating coordinate frame.)

The 3D lidar system 270 may scan a particular point (e.g., pixel) in its field of view by adjusting the angular orientation w of the transmitter and the angular orientation y of the transmitter's movable mirror to the desired scan point (ω, ψ) and emitting a laser beam from the transmitter 104. Accordingly, the 3D lidar system 270 may systematically scan its field of view by adjusting the angular orientation ω of the transmitter and the angular orientation y of the transmitter's movable mirror to a set of scan points (ωᵢ, ψⱼ) and emitting a laser beam from the transmitter 104 at each of the scan points.

Assuming that the optical component(s) (e.g., movable mirror 256) of a lidar transceiver remain stationary during the time period after the transmitter 104 emits a laser beam 110 (e.g., a pulsed laser beam or “pulse” or a CW laser beam) and before the receiver 106 receives the corresponding return beam 114, the return beam generally forms a spot centered at (or near) a stationary location L0 on the detector. This time period is referred to herein as the “ranging period” or “listening period” of the scan point associated with the transmitted beam 110 and the return beam 114.

In many lidar systems, the optical component(s) of a lidar transceiver does not remain stationary during the ranging period of a scan point. Rather, during a scan point's ranging period, the optical component(s) may be moved to orientation(s) associated with one or more other scan points, and the laser beams that scan those other scan points may be transmitted. In such systems, absent compensation, the location Li of the center of the spot at which the transceiver's detector receives a return beam 114 generally depends on the change in the orientation of the transceiver's optical component(s) during the ranging period, which depends on the angular scan rate (e.g., the rate of angular motion of the movable mirror 256) and the range to the object 112 that reflects the transmitted light. The distance between the location Li of the spot formed by the return beam and the nominal location L0 of the spot that would have been formed absent the intervening rotation of the optical component(s) during the ranging period is referred to herein as “walk-off.”

Referring to FIG. 2D, a block diagram of a transmitter-receiver optical subassembly (TROSA) 281 is shown, according to some embodiments. In some embodiments, the TROSA 281 may include a TOSA 280, an optical detector 287, a beam splitter 283, signal conditioning electronics 289, an analog to digital (A/D) converter 290, controller 292, and digital input/output (I/O) electronics 293. In some embodiments, the TROSA components illustrated in FIG. 2D are integrated onto a common substrate 282 (e.g., printed circuit board, ceramic substrate, etc.). In some embodiments, the TROSA components illustrated in FIG. 2D are individually mounted to a common substrate 282. In some embodiments, groups of these components are packaged together and the integrated package(s) is/are mounted to the common substrate.

The TOSA 280 may include one or more light sources and may operate the light source(s) safely within specified safety thresholds. A light source of the TOSA may emit an optical signal (e.g., laser beam) 285.

A return signal 284 may be detected by the TROSA 281 in response to the optical signal 285 illuminating a particular location. For example, the optical detector 287 may detect the return signal 284 and generate an electrical signal 288 based on the return signal 284. The controller 292 may initiate a measurement window (e.g., a period of time during which collected return signal data are associated with a particular emitted light signal 285) by enabling data acquisition by optical detector 287. Controller 292 may control the timing of the measurement window to correspond with the period of time when a return signal is expected in response to the emission of an optical signal 285. In some examples, the measurement window is enabled at the time when the optical signal 285 is emitted and is disabled after a time period corresponding to the time of flight of light over a distance that is substantially twice the range of the lidar device in which the TROSA 281 operates. In this manner, the measurement window is open to collect return light from objects adjacent to the lidar device (e.g., negligible time of flight), objects that are located at the maximum range of the lidar device, and objects in between. In this manner, other light that does not contribute to a useful return signal may be rejected.

In some embodiments, the signal analysis of the electrical signal 288 produced by the optical detector 287 is performed by the controller 292, entirely. In such embodiments, the signals 294 provided by the TROSA 281 may include an indication of the distances determined by controller 292. In some embodiments, the signals 294 include the digital signals 291 generated by the A/D converter 290. These raw measurement signals 291 may be processed further by one or more processors located on board the lidar device or external to the lidar device to arrive at a measurement of distance. In some embodiments, the controller 292 performs preliminary signal processing steps on the signals 291 and the signals 294 include processed data that are further processed by one or more processors located on board the lidar device or external to the lidar device to arrive at a measurement of distance.

In some embodiments, a lidar device (e.g., a lidar device 100, 202, 250, or 270) includes multiple TROSAs 281. In some embodiments, a delay time is enforced between the firing of each TROSA and/or between the firing of different light sources within the same TROSA. In some examples, the delay time is greater than the time of flight of the light signal 285 to and from an object located at the maximum range of the lidar device, to reduce or avoid optical cross-talk among any of the TROSAs 281. In some other examples, an optical signal 285 is emitted from one TROSA 281 before a return signal corresponding to a light signal emitted from another TROSA 281 has had time to return to the lidar device. In these embodiments, there may be a sufficient spatial separation between the areas of the surrounding environment interrogated by the light signals of these TROSAs to avoid optical cross-talk.

In some embodiments, digital I/O 293, A/D converter 290, and signal conditioning electronics 289 are integrated onto a single, silicon-based microelectronic chip. In another embodiment, these same elements are integrated into a single gallium-nitride or silicon based circuit that also includes components of the TOSA 280 (e.g., an illumination driver). In some embodiments, the A/D converter 290 and controller 292 are combined as a time-to-digital converter.

As depicted in FIG. 2D, return light 284 reflected from the surrounding environment is detected by optical detector 287. In some embodiments, optical detector 287 includes one or more avalanche photodiodes (APDs) and/or single-photon avalanche diodes (SPADs). Any suitable optical detector may be used. In some embodiments, optical detector 287 generates an output signal 288 that is amplified by signal conditioning electronics 289. In some embodiments, signal conditioning electronics 289 include an analog trans-impedance amplifier. However, in general, the amplification of output signal 288 may include multiple amplifier stages. In this sense, an analog transimpedance amplifier is provided by way of non-limiting example, as many other analog signal amplification schemes may be used.

In some embodiments, the amplified signal is communicated to A/D converter 290, and the digital signals generated by the A/D converter are communicated to controller 292. Controller 292 may generate an enable/disable signal to control the timing of data acquisition by ADC 290.

As depicted in FIG. 2D, the optical signal 285 emitted from the TROSA 281 and the return signal 284 directed toward the TROSA 281 share a common path within the lidar device. In the embodiment depicted in FIG. 2D, the return light 284 is separated from the emitted light 285 by a beam splitter 283. The beam splitter may direct the light 285 emitted by the TOSA 280 toward the lidar device's environment, and direct the return light 284 to the optical detector 287. Any suitable beam splitter may be used, including (without limitation) a polarizing beam splitter, nonpolarizing beam splitter, dielectric film, etc.). Some non-limiting examples of suitable beam splitters are described in International Patent Publication No. WO 2017/164989.

### Distributed Sensor Systems

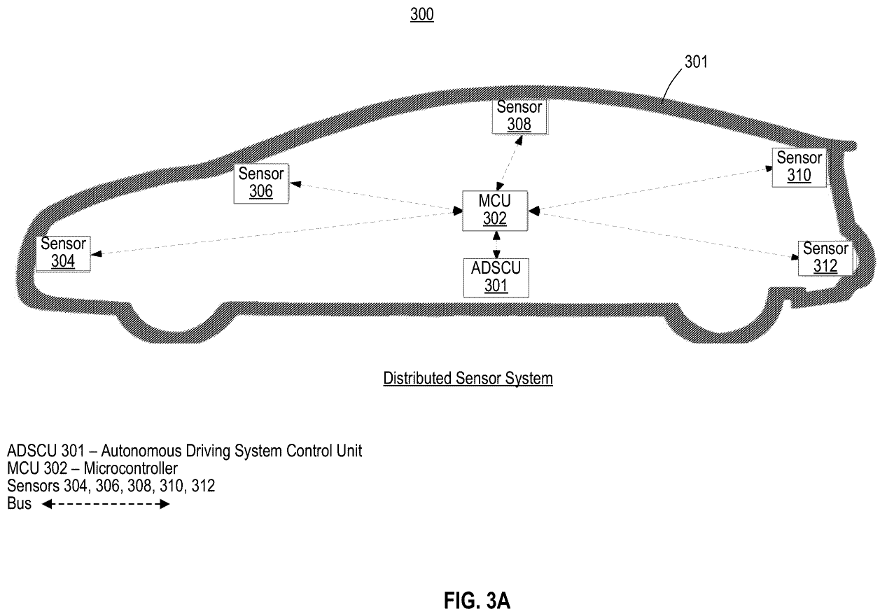

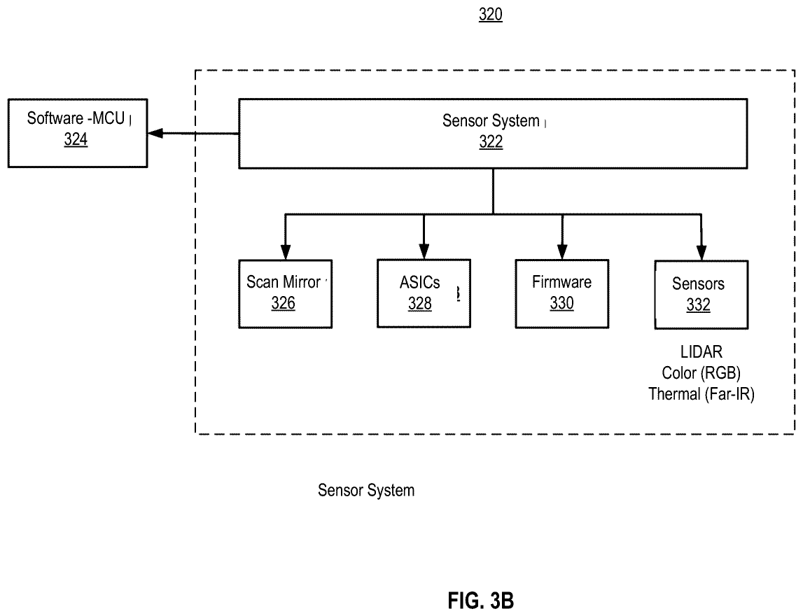

FIG. 3A is an illustration of a distributed sensor system 300 installed in vehicle 301 utilizing a suite of sensors coupled to an automotive microcontroller unit (MCU) 302, in accordance with some embodiments. As illustrated, the suite of sensors includes a plurality of sensor modules 304, 306, 308, 310, and 312. The term “sensor module” is intended to cover any type of sensor module, for example, including single sensor modules, multi-sensor modules, or sensor modules having one or more sensors and associated hardware and/or software. In addition, the types of sensor(s) within a sensor module may vary depending on the configuration of the system 300. In certain instances, a sensor module may include a single sensor (hereinafter, “single sensor module”) such as a single-channel lidar device or multiple sensors (hereinafter, “multi-sensor module”) such as a plurality of related lidar sensors in a single module. A multi-sensor module may include a plurality of integrated sensors, a plurality of discrete sensors, or a combination thereof. In certain instances, the multi-sensor module may include one or more lidar sensors or other types of sensors that are associated with each other or packaged within the module. As shown in FIG. 3A, the suite of sensor modules may be distributed in a variety of locations in the vehicle 301. Correlated sensor data from the various sensor modules can be provided to the MCU 302 for analysis and decision processing. The connectivity between the sensor modules and the MCU 302 may be provided by a sensor bus that can transmit sensor data in a serial or parallel manner (e.g., using a parallel bus).

MCU 302 may be coupled to an autonomous driving system control unit (hereinafter, “ADSCU”) 301. In certain embodiments, the ADSCU 301 may provide sensor instructions and information to MCU 302. For instance, to facilitate signal processing, the ADSCU 301 may instruct different sensor modules in the vehicle 301 (or other vehicle) to use the same framerate when sensing the environment.

In some examples, at least one sensor module is configured to provide (or enable) 3-D mapping of an environment surrounding the vehicle 301. In certain examples, at least one sensor module is used to provide autonomous navigation for the vehicle 301 within an environment. In one example, each sensor module includes at least one lidar system, device, or chip. The lidar system(s) included in each sensor module may include any of the lidar systems disclosed herein. In some examples, at least one sensor module may be or include a different type of sensor (e.g., camera, radar, etc.). In one example, the vehicle 301 is a car; however, in other examples, the vehicle 301 may be a truck, boat, plane, drone, vacuum cleaner (e.g., robotic vacuum cleaner), robot, train, tractor, ATV, spaceship, or any other type of vehicle or moveable object.

Further, in some embodiments, the suite of sensor modules can be installed in or on a variety of objects that are mobile or stationary. For example, a suite of sensor modules may be distributed in a variety of locations around a stadium, a warehouse, a road intersection, or other facility or location, for security monitoring, video streaming, or other purposes. In another example, a suite of sensor modules may be distributed in a variety of locations on a survey plane, a survey robot, a ship, or any other mobile objects (or even static objects) for monitoring an environment near these objects.

As previously described above, a sensor module may include a single sensor or multiple sensors and may support various types of sensors, such as a lidar transceiver, a thermal/far IR sensor, a visible/near IR sensor, a camera, an imaging sensor, or other types of sensors. The sensor module may be provided in a variety of shapes or form factors and/or may have a modular design. In one example, the sensor module can be or include rectangular or wedge-shaped components that may be tiled together and/or stacked to achieve a desired shape or size (e.g., to be positioned at a corner). These different shapes can allow the sensor module to be configured for FOV, sensor range, scan rate, framerate, etc. Based on a particular configuration of the sensor module and corresponding FOV, different scan patterns and resolutions may be implemented.

FIG. 3B is an illustration of a framework 320 for a sensor system 322, in accordance with some embodiments. The sensor system 322 may be supported by an MCU 324 and its associated software. The sensor system 322 may include a scan mirror 326, one or more application specific integrated circuits (ASICs) 328, firmware 330, and a suite of sensor modules 332 (or simply sensors 332). In some embodiments, the scan mirror 326 may be a dual-axis scanning mirror. For instance, the scan mirror 326 may be controlled to achieve a 2D scanning along a vertical axis (or servo axis) and a horizontal axis (or resonant axis). In some embodiments, the suite of sensors 332 may support a combination of sensor modules as described above and may include various sensor types including lidar, color cameras (e.g., RGB cameras), thermal imaging devices (Far-IR), or other sensor types known to one of skill in the art. The sensor system 322 is able to receive data signals from the combination of sensor modules, correlate the sensor data, and process the correlated sensor data, to make timely decisions based thereon.

For autonomous vehicles to perceive a surrounding environment and react accordingly, a variety of techniques may be applied to collate data from the multiple sensor modules. In particular, it may be necessary to collate data from different sensor modules including different types of sensor modules for dynamic and spatial analysis/inference. For instance, data from color cameras (RGB) and lidar sensors may be collated for dynamic and spatial analysis/inference.

In some embodiments, to achieve better synchronization, alignment, and/or overlay of data obtained from different sensor modules, it can be desirable to use a same framerate (or sampling rate) for data collected from the sensor modules included in a suite of sensor modules. In one example, at least two of the sensor modules included in a vehicle can have the same framerate.

In various applications, however, due to manufacturing variations and/or changes in an operating environment (e.g., temperature changes), the actual framerate for a sensor module may vary or deviate from a desired framerate (e.g., a framerate configured for a system). This can cause the sensor module to collect or provide data at a framerate that is different from a framerate used by a different sensor module in the suite of sensor modules. Such differences in framerate can make it difficult to synchronize data across the sensor modules. Accordingly, controlling framerate for the sensor modules in a suite of sensor modules can be important, especially when the sensor modules are operated under a variety of environmental conditions.

To achieve this objective, according to one embodiment, the firmware 330 (e.g., including a control algorithm included in a control & data acquisition unit) associated with a sensor module 332 may be configured to control the sensor module 332 to achieve a constant, predefined framerate. In one example, the firmware 330 may be configured to control a scan mirror 326 to achieve a constant, predefined framerate (alternatively referred to herein as scan rate) for a lidar sensor, as described herein. In some embodiments, the firmware 330 (or the control algorithm) can be configured to achieve a constant framerate for all the sensor modules 332 in the suite of sensor modules 332. This can facilitate frame-to-frame synchronization of data obtained from the sensor modules 332. The techniques used to control the framerate for a sensor module are described in further detail below.

Dual-Axis Scanners with a Constant Framerate

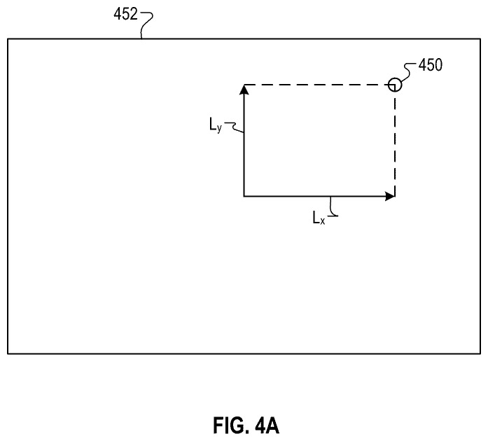

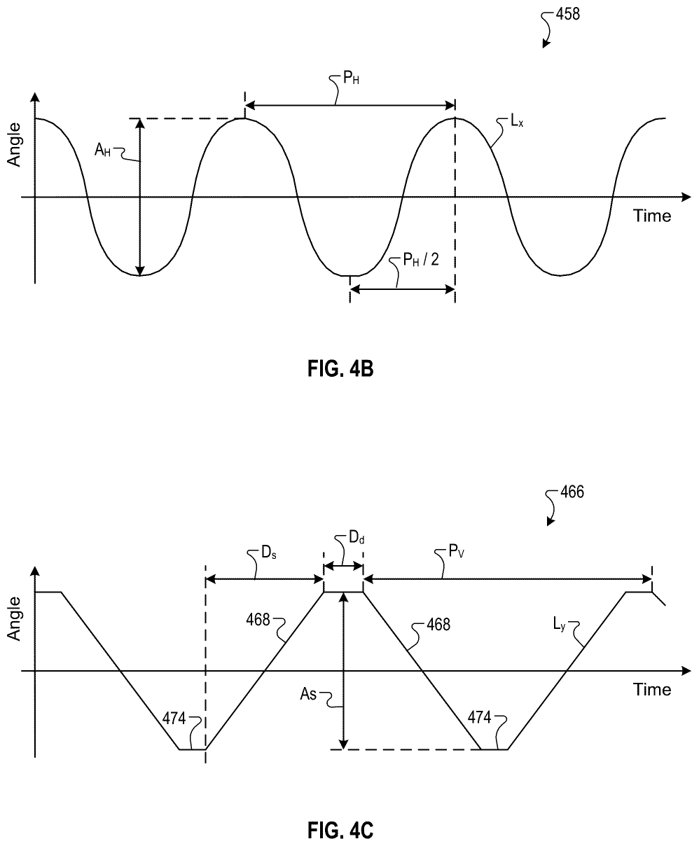

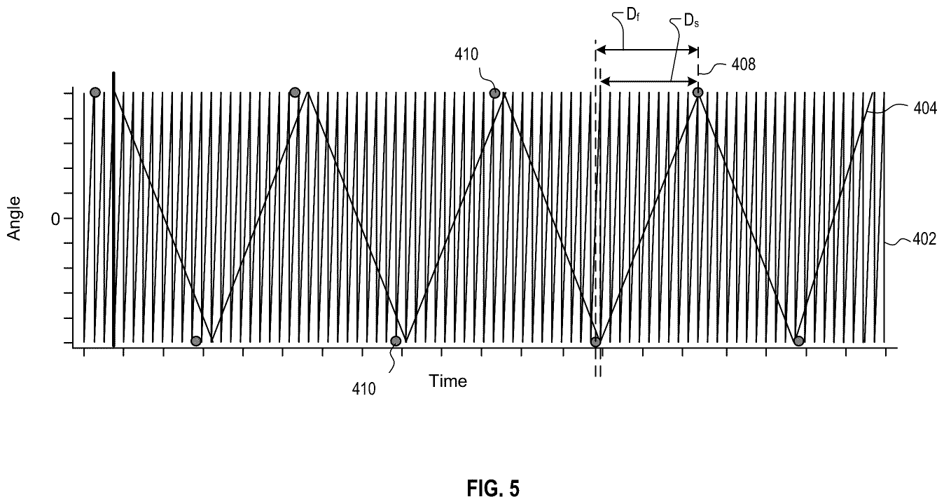

In various examples, a dual-axis lidar device can scan an environment by emitting optical signals into the environment and detecting reflections of the optical signals. Referring to FIG. 4A, for example, an optical signal can be emitted toward a location 450 in a field of view 452 for the lidar device. The location 450 of the optical signal can have a horizontal component Lₓ (e.g., an angle or position in a horizontal direction) and a vertical component L_{y} (e.g., an angle or position in a vertical direction). The horizontal component Lₓ and vertical component L_{y} can vary over successive optical signals, such that the locations 450 of the optical signals can vary to cover the entire field of view 452 during the scan.

FIG. 4B is a plot of an example horizontal scan profile 458 showing how the horizontal component Lₓ of the optical signal location can vary over time during a scan. In the depicted example, the horizontal component Lₓ oscillates sinusoidally with an amplitude A_{H} (e.g., a peak-to-peak variation) and a period P_{H} (alternatively referred to herein as a “horizontal scan period”). A time interval between successive maximum and minimum peaks can be referred to herein as a “half horizontal scan period” (e.g., P_{H}/2). While FIG. 4B depicts a sinusoidal variation, it is understood that the horizontal component Lₓ can vary over time in a different manner (e.g., triangle wave, piecewise linear wave, etc.). The variation in the horizontal component Lₓ can be achieved, for example, by oscillating a mirror or other component (e.g., an emitter) in the lidar device about a vertical axis, as described herein. In some instances, the mirror or other component can oscillate at a resonant frequency, which can vary with temperature or other operating conditions and/or can vary from one lidar device to the next (e.g., due to manufacturing imperfections).

FIG. 4C is a plot of an example vertical scan profile 466 showing how the vertical component L_{y} of the optical signal location can vary during a scan. In the depicted example, the vertical component L_{y} varies linearly between maximum and minimum values and remains constant at the maximum and minimum values for periods of time. The instances when the vertical component L_{y} is increasing or decreasing can be referred to herein as “vertical swipes” 468. Each vertical swipe 468 can have a vertical swipe duration Dₛ and an amplitude Aₛ (e.g., a difference between the maximum and minimum values). A rate at which the vertical location changes during a vertical swipe 468 can be referred to herein as a “vertical swipe speed” or “vertical swipe slope” (e.g., in radians/second). The instances when the vertical component L_{y} is constant (e.g., between two consecutive vertical swipes 468) can be referred to herein as “buffer periods” 474 (or “dead time”), which can have a duration D_{d}. A period P_{V} of one full cycle in the vertical scan profile 466 can be referred to as a “vertical scan period.” The period P_{V} can vary over time due to variations in the duration D_{d} of the buffer periods 474, as described herein.

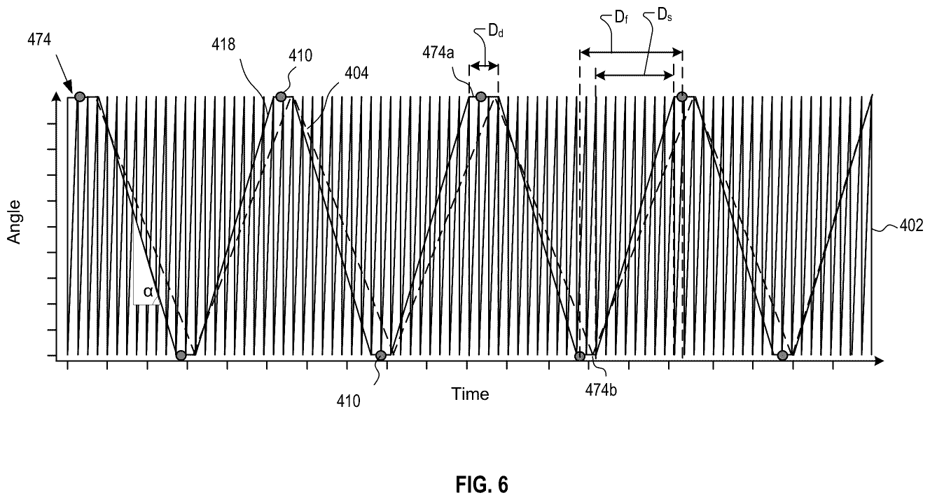

FIGS. 5 and 6 illustrate examples in which a horizontal scan profile and a vertical scan profile for a lidar device (or other dual-axis scanners) are superimposed over one another. In the depicted examples, the horizontal scan profile has a higher frequency compared to the vertical scan profile, with multiple horizontal scan periods being encompassed within a single vertical scan period (e.g., P_{V}>P_{H}). In such instances, a rate at which the lidar scanner completes a full scan can be limited by a time required to move the scan location across the vertical field of view. For example, the lidar scanner in these examples can complete multiple horizontal scan cycles (e.g., having period P_{H}, and covering a width of the field of view) during a time it takes to complete one vertical swipe (covering a height of the vertical field of view). In various examples, the time required to complete a scan can be referred to herein as a “scan duration” (e.g., in seconds). The scan duration can be equal to swipe duration Dₛ plus dead time D_{d}. Likewise, a rate at which the lidar device can complete full scans (referred to as “scan rate,” e.g., in scans/second) can be given by

$$Scan Rate = \frac{1}{Scan Duration} = \frac{1}{{D}_{s} + {D}_{d}} .$$

In various examples, the scan rate for the lidar sensor may not correspond to a desired framerate for a sensor system (e.g., sensor system 322). For example, the sensor system may include another type of sensor (e.g., a camera) having a framerate (e.g., in images/second) that is not equal to the lidar scan rate. Advantageously, the systems and methods described herein are able to achieve a lidar scan rate that matches or is compatible with the desired framerate for the sensor system.

FIG. 5 illustrates an example of a conventional lidar scan pattern having a scan rate that is inconsistent with a desired framerate. The scan pattern includes a horizontal scan profile 402 and a vertical scan profile 404. Unlike the vertical scan profile described above for FIG. 4C (vertical scan profile 466), the vertical scan profile in this example does not include any buffer periods or dead time. The vertical scan profile 404 has a lower frequency compared to the horizontal scan profile 402, and thus a time required to complete a full scan can be limited by the slower vertical scan profile 404. In other examples, the vertical scan profile 404 may have a higher frequency compared to the horizontal scan profile 402, and the time to complete a full scan may be limited by the horizontal scan profile 402 in such instances.

In an ideal situation, the swipe duration Dₛ (e.g., or time to complete one vertical scan) would be the same as a target or desired frame duration D_{f} for the system (e.g., defined by a system operator or by a different sensor in the system); however, due to manufacturing variations and/or environmental changes, the swipe duration Dₛ is often different from the target frame duration D_{f}. In the depicted example of FIG. 5, the swipe duration Dₛ is a little smaller than the target frame duration D_{f}, as indicated by dots 410 in the scan pattern. While the difference between the swipe duration Dₛ and the target frame duration D_{f} may be small, an accumulated difference can become significant over time. Such deviations can make frame-to-frame synchronization of data from different sensors challenging or even impossible.

Referring again to FIG. 4C, to achieve a constant, desired framerate for a lidar device or other dual-axis scanner, a vertical swipe speed (e.g., a slope of the vertical swipes 468) can be adjusted and buffer periods 474 can be added between vertical scans. The combination of the vertical swipe speed adjustment and the introduction of buffer periods may allow the lidar scan duration (e.g., swipe duration Dₛ plus dead time D_{d}) to remain aligned with a desired frame duration (e.g., frame duration D_{f}). For example, through the vertical swipe speed adjustment and the addition of buffer periods between vertical scans, the starting or ending timepoint of a vertical scan can be controlled to be in line with a desired starting or ending timepoint for the desired frame duration D_{f}.

In various examples, the buffer period 474 (alternatively referred to as “dead time” or “wait time”) can refer to a time period when the vertical scan motion is paused and the horizontal scan motion continues, in an effort to realign the lidar scan duration (or lidar scan rate) with the desired frame duration (or desired framerate). In certain implementations, a length of the buffer period 474 can be a multiple of a time required to complete a cycle or scan in the horizontal scan profile (e.g., horizontal scan profile 458), such that the duration of the buffer period 474 can be equal to a duration of an integer number of cycles or scans (e.g., 1, 2, 3, or 4) in the horizontal scan profile (e.g., an integer number of horizontal scan periods P_{H} or half horizontal scan periods P_{H}/2). Additionally or alternatively, the buffer period can be adjusted, as needed, at the beginning or end of each successive vertical scan to achieve the desired frame duration. This can involve, for example, adjusting a duration of a buffer period 474 to cover more or fewer horizontal cycles or scans of the horizontal scan profile. For example, the buffer period 474 after one vertical scan can be different from the buffer period 474 after another vertical scan. On average, the buffer period 474 for the lidar device can be adjusted to satisfy the desired scan duration.

FIG. 6 illustrates an exemplary scenario for achieving the desired scan duration (or desired scan rate) through the adjustment of the vertical swipe speed and the addition of buffer periods 474. The desired frame duration D_{f} in this example is the same as in FIG. 5, as indicated by the dots 410. In FIG. 6, the previous vertical scan profile 404 (from FIG. 5) is shown with a dotted line, and an adjusted vertical scan profile 418 is shown with a solid line. The adjusted vertical scan profile 418 has been adjusted to achieve the desired frame duration D_{f}. In the depicted implementation, for example, vertical swipes in the adjusted vertical scan profile 418 have a larger slope when compared to the vertical swipes in the vertical scan profile 404, which indicates a vertical swipe speed for the adjusted vertical scan profile 418 is higher. That is, it takes less time to complete a vertical swipe in the adjusted vertical scan profile 418, compared to the vertical scan profile 404.

In addition, unlike the vertical scan profile 404, the adjusted vertical scan profile 418 includes buffer periods 474 after one or more vertical swipes (e.g., after each vertical swipe), as indicated by the top and bottom flat portions of the adjusted vertical scan profile 418. The lengths of the buffer periods 474 can vary. For example, the duration of buffer period 474a is equal to three cycles of the horizontal scan profile 402 (e.g., three horizontal scan periods P_{H}), and the duration of buffer period 474b is equal to two cycles of the horizontal scan profile 402 (e.g., two horizontal scan periods P_{H}). Adjusting the buffer period duration in this manner can allow the lidar scan duration to be realigned with the desired frame duration D_{f}, as can be seen in FIG. 6, in which all dots 410 fall within the buffer periods 474. When the buffer periods 474 are added to the vertical swipes, the actual scan duration of the adjusted vertical scan profile 418 is able to match the desired frame duration D_{f} (e.g., on average, over time).

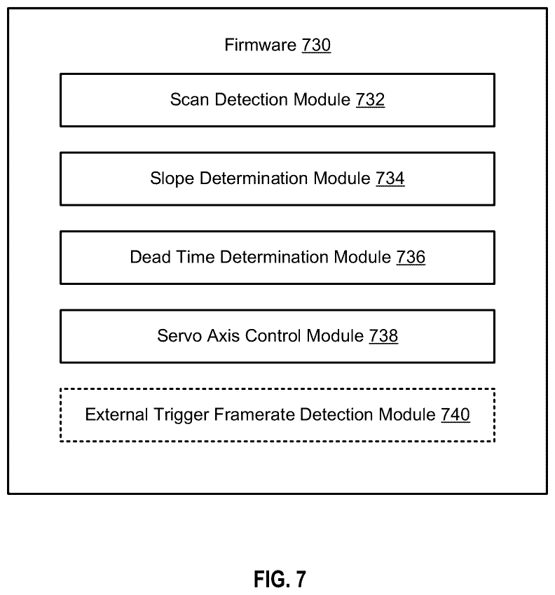

While FIG. 6 depicts a specific vertical swipe speed (e.g., the slope of a vertical swipe) and specific buffer periods 474, it is understood that the vertical swipe speed and/or the durations of the buffer periods 474 can vary and change from scanner to scanner and/or from one application to another (e.g., due to changes in temperature or other operating conditions that may affect actual scan speeds). Techniques for determining the buffer periods and the vertical swipe speed are further described with reference to FIG. 7 for exemplary purposes.

FIG. 7 is an illustration of an example firmware 730 (or control algorithm) for controlling a dual-axis scanner (e.g., a lidar device) to scan at a constant scan duration or scan rate in accordance with some embodiments. The dual-axis scanner may be configured to scan along a vertical axis and a horizontal axis to achieve a desired scan rate (e.g., with an adjusted vertical scan profile matching the desired frame duration D_{f} as described above with reference to FIG. 6). As illustrated in FIG. 7, the firmware 730 may include a scan detection module 732, a slope determination module 734, a dead time determination module 736, and a servo axis control module 738. In some embodiments, the firmware 730 optionally includes an external trigger framerate detection module 740. The different modules 732-740 can work cooperatively to achieve a desired scan rate for the dual-axis scanner, which may be equal to a desired framerate for multiple sensor modules included in a suite of sensor modules (e.g., in sensor system 300).

In various examples, the scan detection module 732 can be used to determine the horizontal scan period P_{H} of a dual-axis scanner. As described herein, the horizontal scan period P_{H} can vary from scanner to scanner or due to changes in operating conditions (e.g., temperature). The scan detection module 732 can be used to measure the horizontal scan period P_{H} for a scanner at any given time. For example, the scan module 732 can monitor the horizontal scan period P_{H} and report the horizontal scan period P_{H} to the slope determination module 734.

In some examples, the slope determination module 734 can be used to determine the vertical swipe slope or vertical swipe duration Dₛ of the scanner based on the horizontal scan period P_{H}. The vertical swipe duration Dₛ can be, for example, an integer number of half horizontal scan periods (e.g., P_{H}/2), such that the vertical swipe duration Dₛ can be determined from

$${D}_{s} = {N}_{1} \frac{{P}_{H}}{2} ,$$

where N₁ is an integer greater than zero (e.g., any integer from 1 to 100, from 5 to 20, or about 5, about 10, about 15, or about 20). Additionally or alternatively, the vertical swipe duration Dₛ can be determined from

$${D}_{s} = \frac{{P}_{H}}{2} [ rounddown ( \frac{{D}_{f}}{{p}_{H} / 2} ) - {N}_{2} ] ,$$

where N₂ is an integer greater than or equal to zero (e.g., any integer from 1 to 10, or from 1 to 5), D_{f} is the target frame duration, and “rounddown” refers to rounding the quantity D_{f}/(P_{H}/2) down to the nearest integer.

In some embodiments, the time within the target frame duration D_{f} that is not covered by a vertical swipe may be covered by a buffer period or dead time. The exact duration of each buffer period may be flexibly adjusted, to allow the scan duration (e.g., vertical swipe duration Dₛ plus dead time D_{d}) to be aligned with the desired frame duration D_{f}. In some embodiments, as described earlier, the dead time D_{d} can be an integer number of horizontal scan periods P_{H} or half horizontal scan periods (e.g., P_{H}/2). In any given vertical scan, however, a difference between the frame duration D_{f} and the vertical swipe duration Dₛ may not be equal to an integer number of half horizontal scan periods. Accordingly, the dead time D_{d} can be varied over successive vertical scans.

Still referring to FIG. 7, the firmware 730 can further include a dead time determination module 736 configured to determine a dead time D_{d} for each vertical scan. In various examples, the dead time D_{d} after any given vertical swipe can be equal to an integer number of half horizontal scan periods, such that the dead time D_{d} can be determined from

$${D}_{d} = {N}_{3} \frac{{P}_{H}}{2} ,$$

where N₃ is an integer greater than zero (e.g., any integer from 1 to 20, from 2 to 12, or from 2 to 8) or any even integer greater than zero (e.g., 2, 4, 6, 8, 10, etc.). Additionally or alternatively, the value of Ns can be adjusted over successive vertical scans to achieve a scan duration (e.g., vertical swipe duration Dₛ plus dead time D_{d}) that is equal to the target frame duration D_{f} on average, over time. In certain examples, the dead time determination module 736 can choose a dead time D_{d} that keeps the end of a scan for the scanner close to the end of a frame for a camera or other sensor associated with the scanner (e.g., in the sensor system 300). When a time between the end of a scan and the end of a frame is too large, for example, the dead time determination module 736 can increase the dead time D_{d} (e.g., by one half horizontal scan period) for one or more scans. Alternatively, when a time between the end of a scan and the end of a frame is too small, the dead time determination module 736 can decrease the dead time D_{d} (e.g., by one half horizontal scan period) for one or more scans. Referring back to FIG. 6, the dead time D_{d} can be adjusted over successive scans, as needed, to keep the end of each frame (as indicated by dots 410) within a buffer period 474.

Referring again to FIG. 7, in some embodiments, the firmware 730 may further include a servo axis control module 738 configured to control the servo axis of a dual-axis scanner to perform vertical scans according to the determined vertical swipe slope and the buffer period or dead time D_{d} after each vertical swipe. For example, the servo axis control module 738 may be configured to control the vertical swipe speed of the servo axis based on the determined vertical swipe slope, and control the wait time after each vertical swipe based on the dead time determined by the dead time determination module 736. Once implemented, the dual-axis scanner may achieve a scan rate that matches a desired framerate (e.g., on average, over time).

In some embodiments, the firmware 730 may optionally include an external trigger framerate detection module 740 configured to detect the framerate of an external trigger and/or determine the target frame duration D_{f}. The external trigger can be provided by a triggering device that is external to or not integrated within the lidar device or dual-axis scanner. The triggering device can be a standalone device (e.g., a camera) that has its own framerate controlling unit. The external trigger may have a predefined framerate, which may or may not be the same as or consistent with the scan rate for a dual-axis scanner. To allow data synchronization between the external trigger and the dual-axis scanner, it may be necessary to use the external trigger to provide the desired framerate or frame duration D_{f} for controlling the dual-axis scanner. For example, the dual-axis scanner may be controlled to have a scan rate that is equal to the framerate of the external trigger. The external trigger framerate detection module 740 may thus be configured to detect the framerate, the frame duration D_{f}, and/or the beginning of each frame for the external trigger, which can be fed into the slope determination module 734 and the dead time determination module 736 to determine a proper vertical swipe duration Dₛ and dead time Da, as described herein. For example, the swipe duration Dₛ and/or dead time D_{d} of the scanner can be adjusted on the fly, as needed, to make the scan duration (e.g., Dₛ+D_{d}) consistent with the frame duration D_{f} of the external trigger (e.g., equal to a time between consecutive trigger signals, on average).

According to one example, the external trigger may be included in or provided by a color (RGB) camera (or other device). The external trigger framerate detection module 740 may allow the dual-axis scanner (e.g., in a lidar device) to scan at a framerate used by the color camera, thereby facilitating frame-to-frame synchronization between the dual-axis scanner and the color camera.

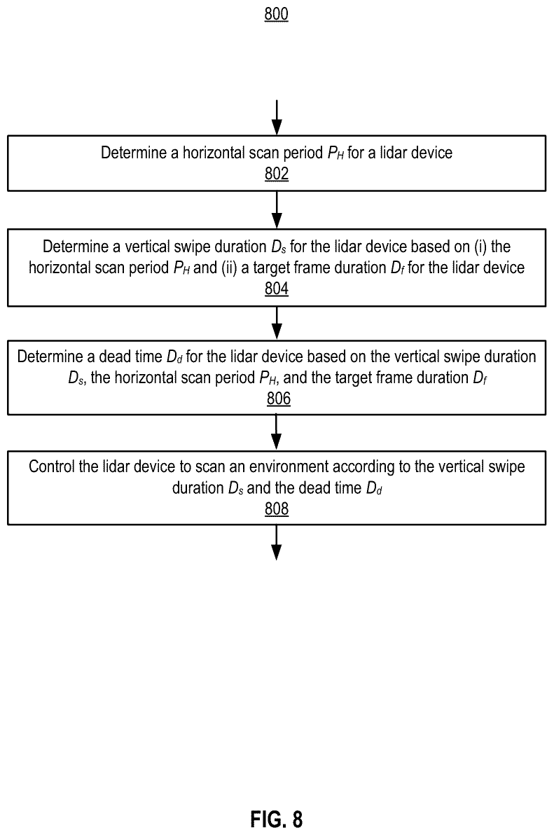

FIG. 8 illustrates an example method 800 for controlling a dual-axis scanner (e.g., a lidar device) to scan at a desired framerate. At step 802, a horizontal scan period P_{H} is determined for a lidar device. The horizontal scan period P_{H} may be used to determine a vertical swipe slope as described above. At step 804, the method includes determining a vertical swipe duration Dₛ for the lidar device based on (i) the horizontal scan period P_{H} and (ii) a target frame duration D_{f} for the lidar device. For example, based on the horizontal scan period P_{H} and the target frame duration D_{f} for the lidar device, the vertical swipe slope can be determined. At step 806, the method includes determining a dead time D_{d} for the lidar device based on the vertical swipe duration Dₛ, the horizontal scan period P_{H}, and the target frame duration D_{f}. For example, after the vertical swipe slope is determined, a remaining time within the target frame duration D_{f} can be determined. The remaining time can be distributed over consecutive vertical swipes as a multiple of the horizontal scan period. At step 808, the method includes controlling the lidar device to scan an environment according to the vertical swipe duration Dₛ and the dead time D_{d}. While the vertical swipe duration Dₛ for each vertical swipe may remain the same, the dead time D_{d} may vary over successive vertical swipes, which can provide flexibility to align the scan duration (e.g., Dₛ+D_{d}) with the target frame duration D_{f}. The method 800 may include fewer or additional steps under certain circumstances.

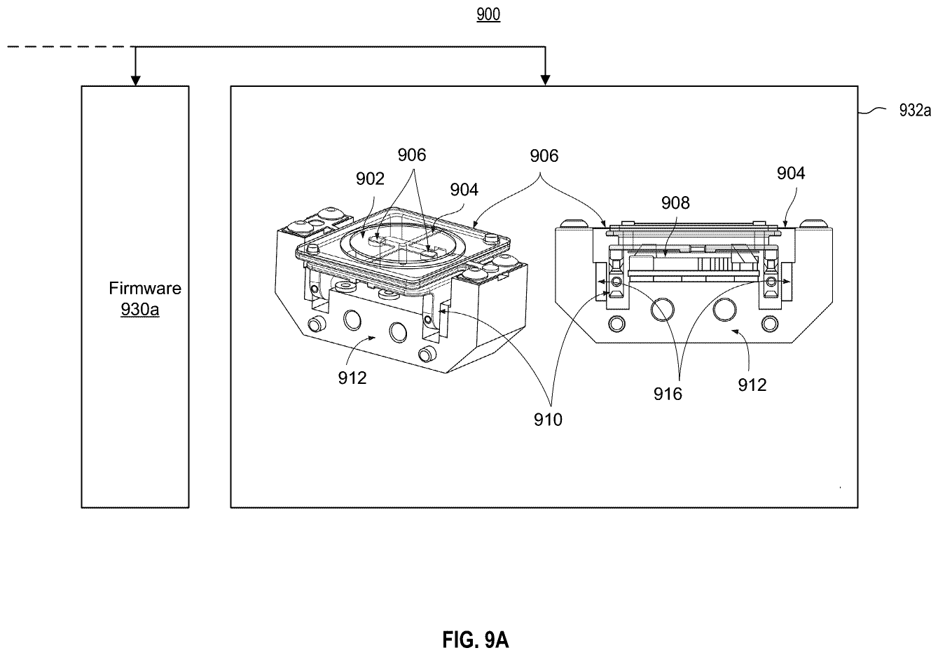

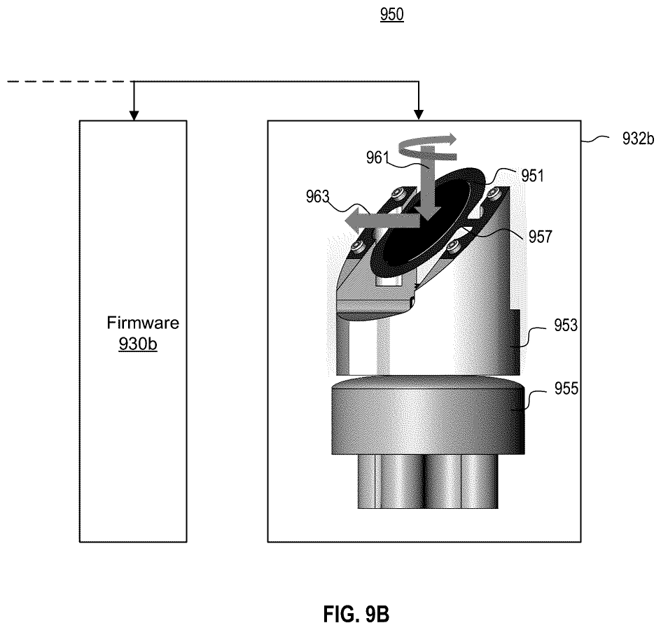

FIG. 9A illustrates one exemplary architecture 900 for controlling a dual-axis scanner, according to embodiments of the disclosure. The architecture 900 may include a firmware 930a (e.g., the firmware 330) and a coupled dual-axis scanner 932a. The firmware 930a may include certain instructions or program codes that, when implemented, control the dual-axis scanner 932a to scan at a vertical scan rate aligned with the desired framerate. The dual-axis scanner 932a may be or include a scanning mirror assembly that includes a primary axis and a secondary axis.

As illustrated in FIG. 9A, the dual-axis scanner 932a may include a resonant spring 904, a resonant spring assembly 906, a rocking chair 910 (with electromagnetic drive coils), a scanner base 912 with a set of two secondary axis propulsion magnets 916, a mirror 902 with a spacer and primary axis propulsion magnets, and an optical sense board 908. The resonant spring 904 is a component of resonant spring assembly 906. In some embodiments, the mirror 902 may be driven to oscillate about a primary axis (e.g., a vertical axis, not shown) at a certain resonant frequency (e.g., around 200 Hz, 129 Hz, etc.) based on movement by the primary axis propulsion magnets 914 and the resonant spring assembly 906. The oscillation about the primary axis can cause a normal vector on a surface of the mirror 902 to move back and forth in a horizontal direction, over a range of angles. A total angular deflection in the horizontal direction can be, for example, +/−30 degrees (60 degrees total). The mirror 902 can be selectively controlled to oscillate about a secondary axis (e.g., a horizontal axis, not shown) using a servomechanism. The oscillation about the secondary axis can cause the normal vector on the surface of the mirror 902 to move back and forth in a vertical direction, over a range of angles. A total angular deflection in the vertical direction can be, for example, +/−9 degrees (18 degrees total). Rotation around the secondary axis may be achieved through the movement of the rocking chair 910 relative to the scanner base 912.

In some embodiments, the firmware 930a may control the scanning mirror assembly to scan at a constant or desired framerate by controlling the movement of the rocking chair 910 relative to the scanner base 912. For example, the firmware 930a may control the rocking chair 910 to adjust the rotation speed around the secondary axis and add a certain dead time after each rotation. The rotation speed and dead time may be dynamically determined and/or adjusted, to achieve a desired vertical swipe speed for the scanning mirror assembly 932a, as described herein. The firmware 930a may be configured to provide such control.

FIG. 9B illustrates another exemplary architecture 950 for controlling a dual-axis scanner, according to embodiments of this disclosure. The architecture 950 may include a firmware 930b (e.g., the firmware 330) and a coupled dual-axis scanner 932b. The firmware 930b may include certain instructions or program codes that, when implemented, control the dual-axis scanner 932b to scan at a constant or desired framerate.

As illustrated, the dual-axis scanner 932b can be or include a rotary 2D scanner that includes a rotational component 955 (e.g., rotational motor) and a scan mirror assembly. The scan mirror assembly includes a scan mirror 951, a rotational base 953, and a mirror-tilting apparatus. The mirror-tilting apparatus includes a pair of flexures 957 (e.g., “flexure bearings”). The scan mirror 951 of the 2D scanner may be mounted on the rotational base 953 to achieve a 360-degree horizontal scan. The rotational base 953 may be driven to rotate about a “spin axis” (e.g., a vertical axis) by a rotational component (e.g., a rotational motor) 955. The spin axis may be orthogonal to a “pivot axis” (e.g., a horizontal axis), and the mirror may be configured to tilt (or “pivot”) about the pivot axis. The spin axis is vertical and the pivot axis is horizontal in the illustrated example in FIG. 9B. The mirror 951 may be mounted on the rotational base 953 through the pair of flexures 957, which can hold the mirror 951 at a desired orientation (e.g., at a desired position and angle) with respect to the rotational base 953. In some embodiments, the mirror may have an initial orientation (or “default orientation”) with respect to the rotational base 953 when the rotational base is not rotating (has an angular velocity of 0 radians/second). In one example, the initial orientation of the mirror 951 may correspond to a 45-degree angle with respect to the spin axis (e.g., the vertical axis), as illustrated in FIG. 9B.

During a scanning process, a laser beam 961 may be emitted by a lidar system in a vertical direction (e.g., parallel to the spin axis) toward a reflective surface of the mirror 951. When the mirror 951 is mounted at a 45-degree angle with respect to the vertical axis, the mirror 951 can reflect the emitted laser 961 to produce a horizontal laser beam 963.

In some embodiments, the mirror 951 may be controlled to rotate at a desired speed about the vertical axis (e.g., to achieve a desired horizontal scan rate) and to oscillate about the horizontal axis (e.g., to achieve a desired vertical swipe speed). The rate of oscillation about the horizontal axis can be chosen based on the rate of rotation about the vertical axis. For example, the vertical swipe speed for the mirror 951 (e.g., a time it takes the mirror to complete one swipe up or down in the vertical direction) can be selected to be equal to (or substantially equal to) an integer number of rotations about the vertical axis. The vertical swipe speed can be further selected to correspond to or be consistent with a desired framerate, as described herein. For example, the vertical swipe speed can be chosen to be slightly less than the desired framerate. A buffer period or dead time can be added to the end of each vertical swipe and the dead time between vertical swipes can be adjusted, as needed, to keep the vertical swipe speed consistent with the desired framerate, as described herein. In some examples, the buffer period can be equal to an integer number of rotations (e.g., 1, 2, 3, or 4 rotations) of the mirror 951 about the vertical axis. The firmware 930b may be configured to control the orientation of the mirror 951.

FIGS. 9A and 9B depict two exemplary dual-axis scanners that can be controlled to scan at a constant or desired framerate using the techniques described herein. Other examples of dual-axis scanners may be similarly controlled.

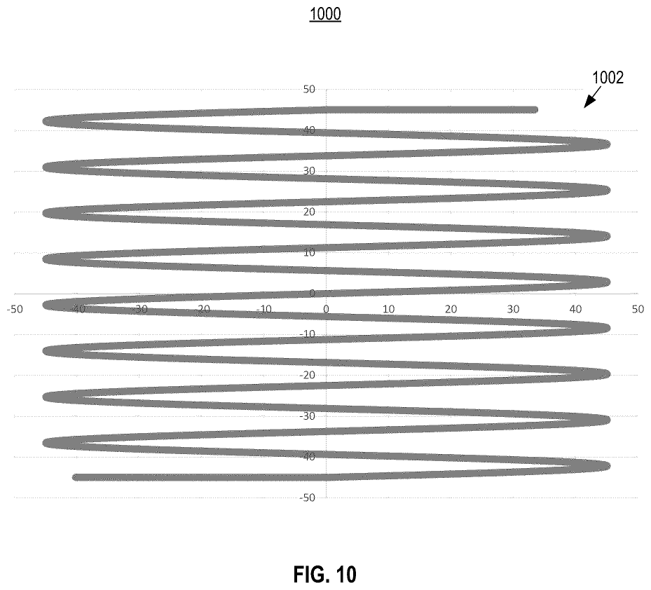

FIG. 10 provides an exemplary scan pattern 1000 for a dual-axis scanner disclosed herein (e.g., scanner 932a). The scan pattern 1000 shows locations in a field of view 1002 of a lidar device where optical signals are emitted during one scan of the lidar device. The scan in this case can be achieved by oscillating a mirror in the lidar device about a vertical axis (to achieve the horizontal variation in the figure) and rotating the mirror about a horizontal axis (to achieve the vertical variation in the figure). The scan pattern may be generated under a wide variety of conditions (e.g., different temperatures) and/or by different dual-axis scanners that are configured to scan at a desired framerate. The scan pattern may remain the same under various conditions and from sensor-to-sensor.

### Some Example Continuous Wave Lidar Systems

As discussed above, some lidar systems may use a continuous wave (CW) laser to detect the range and/or velocity of targets, rather than pulsed TOF techniques. Such systems include continuous wave (CW) coherent lidar systems and frequency modulated continuous wave (FMCW) coherent lidar systems. For example, any of the lidar systems 100, 202, 250, and 270 described above can be configured to operate as a CW coherent lidar system or an FMCW coherent lidar system.

Lidar systems configured to operate as CW or FMCW systems can avoid the eye safety hazards commonly associated with pulsed lidar systems (e.g., hazards that arise from transmitting optical signals with high peak power). In addition, coherent detection may be more sensitive than direct detection and can offer better performance, including single-pulse velocity measurement and immunity to interference from solar glare and other light sources, including other lidar systems and devices.

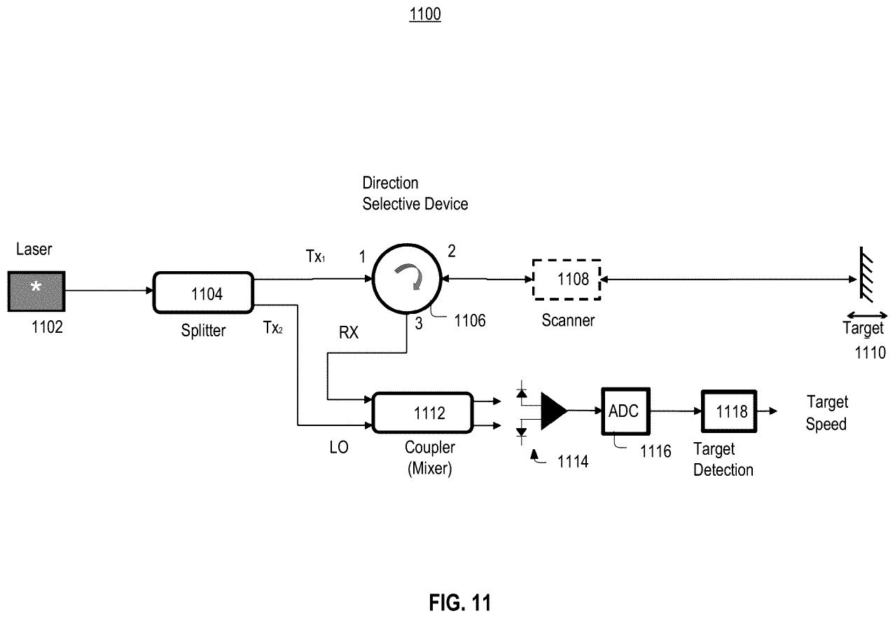

FIG. 11 illustrates an exemplary CW coherent lidar system 1100 configured to determine the radial velocity (or speed) of a target. lidar system 1100 includes a laser 1102 configured to produce a laser signal which is provided to a splitter 1104. The laser 1102 may provide a laser signal having a substantially constant laser frequency.

In one example, a splitter 1104 provides a first split laser signal Tx1 to a direction selective device 1106, which provides (e.g., forwards) the signal Tx1 to a scanner 1108. In some examples, the direction selective device 1106 is a circulator. The scanner 1108 uses the first laser signal Tx1 to transmit light emitted by the laser 1102 and receives light reflected by the target 1110 (e.g., “reflected light” or “reflections”). The reflected light signal Rx is provided (e.g., passed back) to the direction selective device 1106. The second laser signal Tx2 (provided by the splitter 1104) and the reflected light signal Rx are provided to a coupler (also referred to as a mixer) 1112. The mixer may use the second laser signal Tx2 as a local oscillator (LO) signal and mix it with the reflected light signal Rx. The mixer 1112 may be configured to mix the reflected light signal Rx with the local oscillator signal LO. The mixer 612 may provide the mixed optical signal to differential photodetector 614, which may generate an electrical signal representing the beat frequency f_{beat} of the mixed optical signals, where f_{beat}=| f_{Tx2}−f_{Rx}| (the absolute value of the difference between the frequencies of the mixed optical signals). In some embodiments, the current produced by the differential photodetector 1114 based on the mixed light may have the same frequency as the beat frequency f_{beat}. The current may be converted to a voltage by an amplifier (e.g., a transimpedance amplifier (TIA)), which may be provided (e.g., fed) to an analog-to-digital converter (ADC) 1116 configured to convert the analog voltage signal to digital samples for a target detection module 1118. The target detection module 1118 may be configured to determine (e.g., calculate) the radial velocity of the target 1110 based on the digital sampled signal with the beat frequency f_{beat}.

In one example, the target detection module 1118 may identify Doppler frequency shifts using the beat frequency f_{beat} and determine the radial velocity of the target 1110 based on those shifts. For example, the radial velocity of the target 1110 can be calculated using the following relationship:

$${f}_{d} = \frac{2}{λ} {v}_{t}$$

where, f_{d} is the Doppler frequency shift, λ is the wavelength of the laser signal, and vₜ is the radial velocity of the target 1110. In some examples, the direction of the target 1110 is indicated by the sign of the Doppler frequency shift f_{d}. For example, a positive signed Doppler frequency shift may indicate that the target 1110 is traveling towards the system 1100 and a negative signed Doppler frequency shift may indicate that the target 1110 is traveling away from the system 1100.

In one example, a Fourier Transform calculation is performed using the digital samples from the ADC 1116 to recover the desired frequency content (e.g., the Doppler frequency shift) from the digitally sampled signal. For example, a controller (e.g., target detection module 1118) may be configured to perform a Discrete Fourier Transform (DFT) on the digital samples. In certain examples, a Fast Fourier Transform (FFT) can be used to calculate the DFT on the digital samples. In some examples, the Fourier Transform calculation (e.g., DFT) can be performed iteratively on different groups of digital samples to generate a target point cloud.

While the lidar system 1100 is described above as being configured to determine the radial velocity of a target, it should be appreciated that the system can be configured to determine the range and/or radial velocity of a target. For example, the lidar system 1100 can be modified to use laser chirps to detect the velocity and/or range of a target.

Some examples have been described in which a DFT is used to generate points of a point cloud based on a group of samples. However, frequency analysis techniques (e.g., spectrum analysis techniques) other than the DFT may be used to generate points of a point cloud based on a group of samples. Any suitable frequency analysis technique may be used, including, without limitation, Discrete Cosine transform (DCT), Wavelet transform, Auto-Regressive moving average (ARMA), etc.

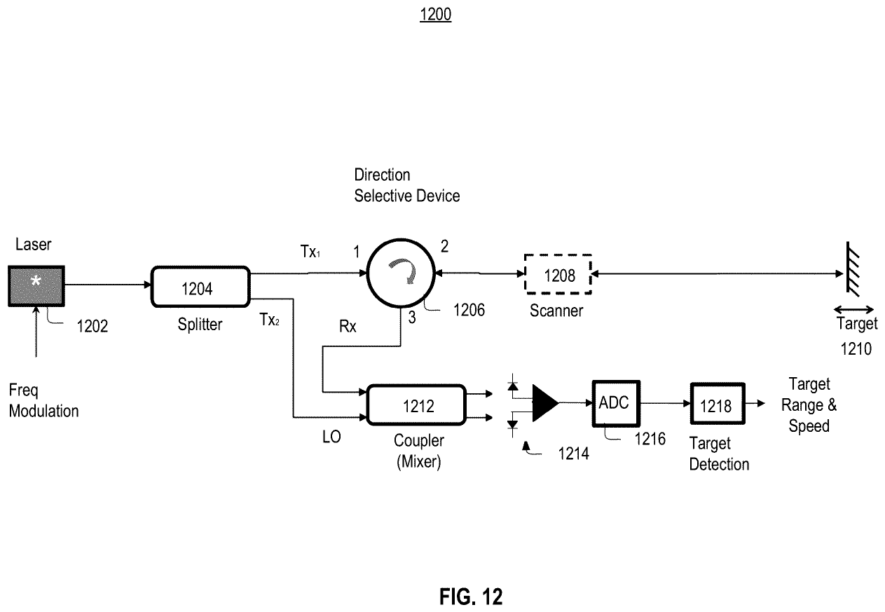

FIG. 12 illustrates an exemplary FMCW coherent lidar system 1200 configured to determine the range and/or radial velocity of a target. lidar system 1200 includes a laser 1202 configured to produce a laser signal which is fed into a splitter 1204. The laser is “chirped” (e.g., the center frequency of the emitted laser beam is increased (“ramped up” or “chirped up”) or decreased (“ramped down” or “chirped down”) over time (or, equivalently, the central wavelength of the emitted laser beam changes with time within a waveband). In various embodiments, the laser frequency is chirped quickly such that multiple phase angles are attained. In one example, the frequency of the laser signal is modulated by changing the laser operating parameters (e.g., current/voltage) or using a modulator included in the laser source 1202; however, in other examples, an external modulator can be placed between the laser source 1202 and the splitter 1204.

In other examples, the laser frequency can be “chirped” by modulating the phase of the laser signal (or light) produced by the laser 1202. In one example, the phase of the laser signal is modulated using an external modulator placed between the laser source 1202 and the splitter 1204; however, in some examples, the laser source 1202 may be modulated directly by changing operating parameters (e.g., current/voltage) or include an internal modulator. Similar to frequency chirping, the phase of the laser signal can be increased (“ramped up”) or decreased (“ramped down”) over time.

Some examples of systems with FMCW-based lidar sensors have been described. However, some embodiments of the techniques described herein may be implemented using any suitable type of lidar sensors including, without limitation, any suitable type of coherent lidar sensors (e.g., phase-modulated coherent lidar sensors). With phase-modulated coherent lidar sensors, rather than chirping the frequency of the light produced by the laser (as described above with reference to FMCW techniques), the lidar system may use a phase modulator placed between the laser 1202 and the splitter 1204 to generate a discrete phase modulated signal, which may be used to measure range and radial velocity.

As shown, the splitter 1204 provides a first split laser signal Tx1 to a direction selective device 1206, which provides (e.g., forwards) the signal Tx1 to a scanner 1208. The scanner 1208 uses the first laser signal Tx1 to transmit light emitted by the laser 1202 and receives light reflected by the target 1210. The reflected light signal Rx is provided (e.g., passed back) to the direction selective device 1206. The second laser signal Tx2 and reflected light signal Rx are provided to a coupler (also referred to as a mixer) 1212. The mixer may use the second laser signal Tx2 as a local oscillator (LO) signal and mix it with the reflected light signal Rx. The mixer 1212 may be configured to mix the reflected light signal Rx with the local oscillator signal LO to generate a beat frequency f_{beat}. The mixed signal with beat frequency f_{beat} may be provided to a differential photodetector 1214 configured to produce a current based on the received light. The current may be converted to voltage by an amplifier (e.g., a transimpedance amplifier (TIA)), which may be provided (e.g., fed) to an analog-to-digital converter (ADC) 1216 configured to convert the analog voltage to digital samples for a target detection module 1218. The target detection module 1218 may be configured to determine (e.g., calculate) the range and/or radial velocity of the target 1210 based on the digital sample signal with beat frequency f_{beat}.

Laser chirping may be beneficial for range (distance) measurements of the target. In comparison, Doppler frequency measurements are generally used to measure target velocity. Resolution of distance can depend on the bandwidth size of the chirp frequency band such that greater bandwidth corresponds to finer resolution, according to the following relationships:

$$Range resolution : Δ R = \frac{c}{2 BW} ( given a perfectly linear chirp ) , and$$

$$Range : R = \frac{{f}_{beat} {cT}_{ChirpRamp}}{2 BW}$$

where c is the speed of light, BW is the bandwidth of the chirped laser signal, f_{beat} is the beat frequency, and T_{ChirpRamp} is the time period during which the frequency of the chirped laser ramps up (e.g., the time period corresponding to the up-ramp portion of the chirped laser). For example, for a distance resolution of 3.0 cm, a frequency bandwidth of 5.0 GHz may be used. A linear chirp can be an effective way to measure range and range accuracy can depend on the chirp linearity. In some instances, when chirping is used to measure target range, there may be range and velocity ambiguity. In particular, the reflected signal for measuring velocity (e.g., via Doppler) may affect the measurement of range. Therefore, some exemplary FMCW coherent lidar systems may rely on two measurements having different slopes (e.g., negative and positive slopes) to remove this ambiguity. The two measurements having different slopes may also be used to determine range and velocity measurements simultaneously.

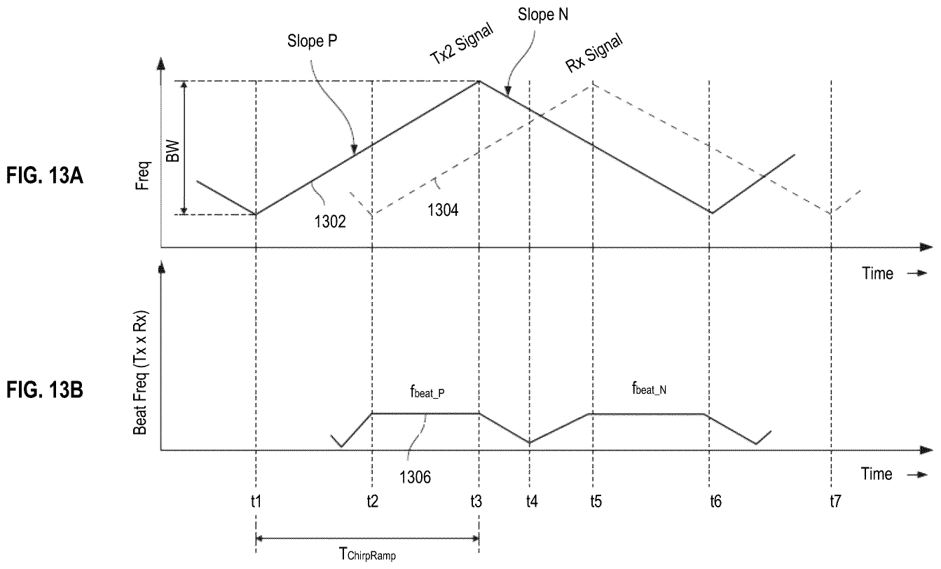

FIG. 13A is a plot of ideal (or desired) frequency chirp as a function of time in the transmitted laser signal Tx (e.g., signal Tx2), depicted in solid line 1302, and reflected light signal Rx, depicted in dotted line 1304. As depicted, the ideal Tx signal has a positive linear slope between time t1 and time t3 and a negative linear slope between time t3 and time t6. Accordingly, the ideal reflected light signal Rx returned with a time delay td of approximately t2−t1 has a positive linear slope between time t2 and time t5 and a negative linear slope between time t5 and time t7.

FIG. 13B is a plot illustrating the corresponding ideal beat frequency f_{beat} 1306 of the mixed signal Tx2×Rx. Note that the beat frequency f_{beat} 1306 has a constant value between time t2 and time t3 (corresponding to the overlapping up-slopes of signals Tx2 and Rx) and between time t5 and time t6 (corresponding to the overlapping down-slopes of signals Tx2 and Rx).

The positive slope (“Slope P”) and the negative slope (“Slope N”) (also referred to as positive ramp (or up-ramp) and negative ramp (or down-ramp), respectively) can be used to determine range and/or velocity. In some instances, referring to FIGS. 13A-13B, when the positive and negative ramp pair is used to measure range and velocity simultaneously, the following relationships are utilized:

$$Range : R = \frac{{cT}_{ChirpRamp} \frac{( {f}_{beat \_ P} + {f}_{beat \_ N} )}{2}}{2 BW} , and$$

$$Velocity : V = \frac{λ \frac{( {f}_{beat \_ P} - {f}_{beat \_ N} )}{2}}{2}$$

where f_{beat_P} and f_{beat_N} are beat frequencies generated during positive (P) and negative (N) slopes of the chirp 1302 respectively and A is the wavelength of the laser signal.

In one example, the scanner 1208 of the lidar system 1200 is used to scan the environment and generate a target point cloud from the acquired scan data. In some examples, the lidar system 1200 can use processing methods that include performing one or more Fourier Transform calculations, such as a Fast Fourier Transform (FFT) or a Discrete Fourier Transform (DFT), to generate the target point cloud from the acquired scan data. Being that the system 1200 is capable of measuring range, each point in the point cloud may have a three-dimensional location (e.g., x, y, and z) in addition to radial velocity. In some examples, the x-y location of each target point corresponds to a radial position of the target point relative to the scanner 1208. Likewise, the z location of each target point corresponds to the distance between the target point and the scanner 1208 (e.g., the range). In one example, each target point corresponds to one frequency chirp 1302 in the laser signal. For example, the samples collected by the system 1200 during the chirp 1302 (e.g., t1 to t6) can be processed to generate one point in the point cloud.

### Additional Embodiments, Computing Devices, and Information Handling Systems

In some embodiments, lidar systems and techniques described herein may be implemented using Silicon photonics (SiP) technologies. SiP is a material platform from which photonic integrated circuits (PICs) can be produced. SiP is compatible with CMOS (electronic) fabrication techniques, which allows PICs to be manufactured using established foundry infrastructure. In PICs, light propagates through a patterned silicon optical medium that lies on top of an insulating material layer (e.g., silicon on insulator (SOI)). In some cases, direct bandgap materials (e.g., indium phosphide (InP)) are used to create light (e.g., laser) sources that are integrated into a SiP chip (or wafer) to drive optical or photonic components within a photonic circuit. SiP technologies are increasingly used in optical datacom, sensing, biomedical, automotive, astronomy, aerospace, augmented reality (AR) applications, virtual reality (VR) applications, artificial intelligence (AI) applications, navigation, image identification, drones, robotics, etc.

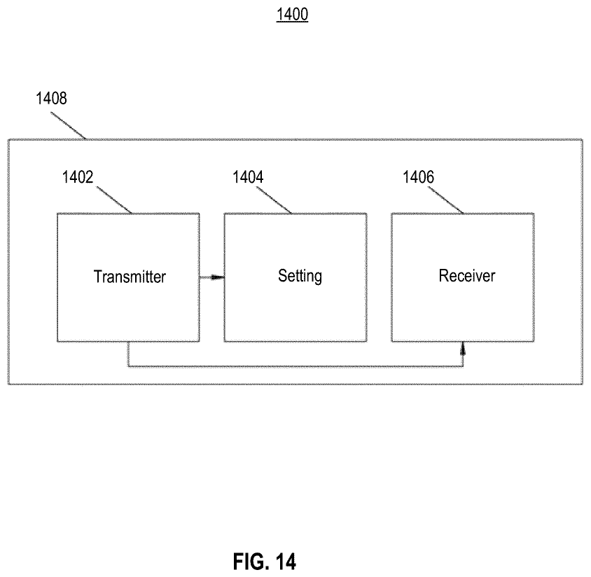

FIG. 14 is a block diagram of a silicon photonic integrated circuit (PIC) 1400 in accordance with aspects described herein. In one example, the lidar systems described herein can be implemented as the PIC 1400. The PIC 1400 includes a transmitter module 1402, a steering module 1404, and a receiver module 1406. As shown, the transmitter module 1402, the steering module 1404, and the receiver module 1406 are integrated on a silicon substrate 1408. In other examples, the transmitter module 1402, the steering module 1404, or the receiver module 1406 may be included on a separate substrate. In some embodiments, the steering module 1404 is used by the PIC 1400 in connection with transmission (e.g., emission) and reception (e.g., collection) of optical signals. In some examples, the silicon substrate 1408 is an SOI substrate with a silicon layer (e.g., between 200 nm and 10 micron thick) disposed over an oxide layer (e.g., approximately 2 mn thickness). In certain examples, the silicon substrate 1408 can include multiple silicon and/or oxide layers.

In one example, the transmitter module 1402 includes at least one laser source. In some examples, the laser source(s) are implemented using a direct bandgap material (e.g., InP) and integrated on the silicon substrate 1408 via hybrid integration. The transmitter module 1402 may also include at least one splitter, a combiner, and/or a direction selective device that are implemented on the silicon substrate 1408 via monolithic or hybrid integration. In some examples, the laser source(s) are external to the PIC 1400 and the laser signal(s) can be provided to the transmission module 1402.

In some embodiments, lidar systems and techniques described herein may be implemented using micro-electromechanical system (MEMS) devices. A MEMS device is a miniature device that has both mechanical and electronic components. The physical dimension of a MEMS device can range from several millimeters to less than one micrometer. Lidar systems may include one or more scanning mirrors implemented as a MEMS mirror (or an array of MEMS mirrors). Each MEMS mirror may be a single-axis MEMS mirror or dual-axis MEMS mirror. The MEMS mirror(s) may be electromagnetic mirrors. A control signal is provided to adjust the position of the mirror to direct light in at least one scan direction (e.g., horizontal and/or vertical). The MEMS mirror(s) can be positioned to steer light transmitted by the lidar system and/or to steer light received by the lidar system. MEMS mirrors are compact and may allow for smaller form-factor lidar systems, faster control speeds, and more precise light steering compared to other mechanical-scanning lidar methods. MEMS mirrors may be used in solid-state (e.g., stationary) lidar systems and rotating lidar systems.

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), network storage device, or any other suitable device and may vary in size, shape, performance, functionality, and price.

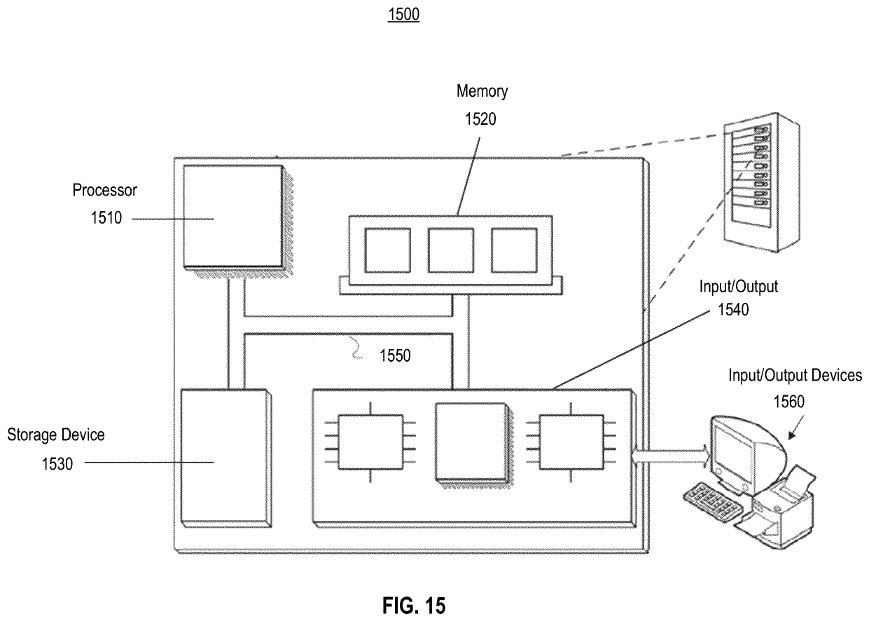

FIG. 15 is a block diagram of an example computer system 1500 that may be used in implementing the technology described in this document. General-purpose computers, network appliances, mobile devices, or other electronic systems may also include at least portions of the system 1500. The system 1500 includes a processor 1510, a memory 1520, a storage device 1530, and an input/output device 1540. Each of the components 1510, 1520, 1530, and 1540 may be interconnected, for example, using a system bus 1550. The processor 1510 is capable of processing instructions for execution within the system 1500. In some implementations, the processor 1510 is a single-threaded processor. In some implementations, the processor 1510 is a multi-threaded processor. In some implementations, the processor 1510 is a programmable (or reprogrammable) general purpose microprocessor or microcontroller. The processor 1510 is capable of processing instructions stored in the memory 1520 or on the storage device 1530.

The memory 1520 stores information within the system 1500. In some implementations, the memory 1520 is a non-transitory computer-readable medium. In some implementations, the memory 1520 is a volatile memory unit. In some implementations, the memory 1520 is a non-volatile memory unit.

The storage device 1530 is capable of providing mass storage for the system 1500. In some implementations, the storage device 1530 is a non-transitory computer-readable medium. In various different implementations, the storage device 1530 may include, for example, a hard disk device, an optical disk device, a solid-date drive, a flash drive, or some other large capacity storage device. For example, the storage device may store long-term data (e.g., database data, file system data, etc.). The input/output device 1540 provides input/output operations for the system 1500. In some implementations, the input/output device 1540 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1530 may be implemented in a distributed way over a network, for example as a server farm or a set of widely distributed servers, or may be implemented in a single computing device.

Although an example processing system has been described in FIG. 15, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array), an ASIC (application specific integrated circuit), or a programmable general purpose microprocessor or microcontroller. A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other units suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA, an ASIC, or a programmable general purpose microprocessor or microcontroller.

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

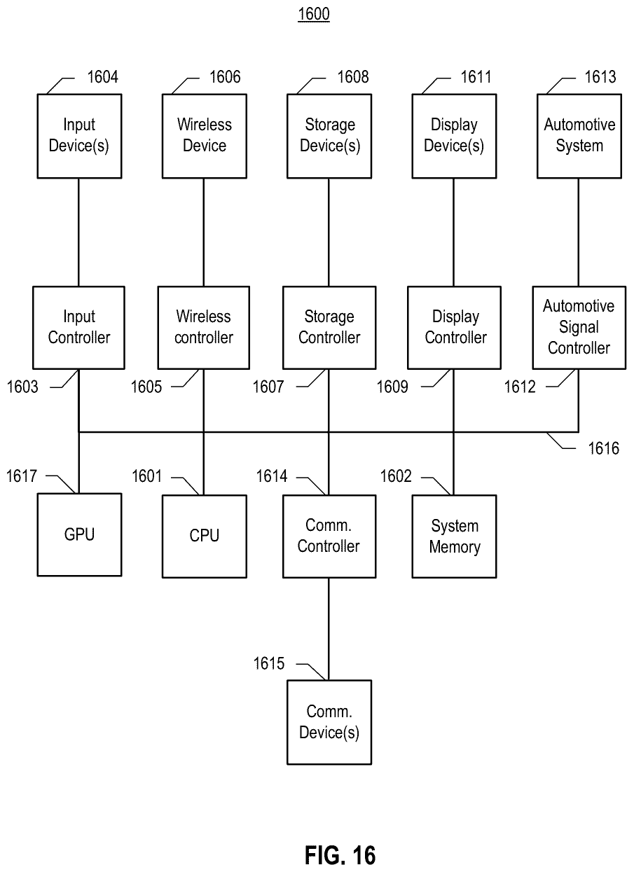

FIG. 16 depicts a simplified block diagram of a computing device/information handling system (or computing system) 1600 according to embodiments of the present disclosure. It will be understood that the functionalities shown for system 1600 may operate to support various embodiments of an information handling system—although it shall be understood that an information handling system may be differently configured and include different components.

As illustrated in FIG. 16, system 1600 includes one or more central processing units (CPU) 1601 that provide(s) computing resources and control(s) the computer. CPU 1601 may be implemented with a microprocessor or the like, and may also include one or more graphics processing units (GPU) 1617 and/or a floating point coprocessor for mathematical computations. System 1600 may also include a system memory 1602, which may be in the form of random-access memory (RAM), read-only memory (ROM), or both.

A number of controllers and peripheral devices may also be provided. For example, an input controller 1603 represents an interface to various input device(s) 1604, such as a keyboard, mouse, or stylus. There may also be a scanner controller 1605, which communicates with a wireless device 1606. System 1600 may also include a storage controller 1607 for interfacing with one or more storage devices 1608 each of which includes a storage medium such as a magnetic tape or disk, or an optical medium that might be used to record programs of instructions for operating systems, utilities, and applications, which may include embodiments of programs that implement various aspects of the techniques described herein. Storage device(s) 1608 may also be used to store processed data or data to be processed in accordance with some embodiments. System 1600 may also include a display controller 1609 for providing an interface to a display device 1611, which may be a cathode ray tube (CRT), a thin film transistor (TFT) display, or other types of display. The computing system 1600 may also include an automotive signal controller 1612 for communicating with an automotive system 1613. A communications controller 1614 may interface with one or more communication devices 1615, which enables system 1600 to connect to remote devices through any of a variety of networks including the Internet, a cloud resource (e.g., an Ethernet cloud, a Fiber Channel over Ethernet (FCOE)/Data Center Bridging (DCB) cloud, etc.), a local area network (LAN), a wide area network (WAN), a storage area network (SAN), or through any suitable electromagnetic carrier signals including infrared signals.

In the illustrated system, all major system components may connect to a bus 1616, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory, computer-readable media with instructions for one or more processors or processing units to cause steps to be performed. It shall be noted that the one or more non-transitory, computer-readable media shall include volatile and non-volatile memory. It shall also be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that has computer code thereon for performing various computer-implemented operations. The medium and computer code may be those specially designed and constructed for the purposes of the techniques described herein, or they may be of the kind known or available to those having skill in the relevant arts. Examples of tangible, computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as that produced by a compiler, and files containing higher level code that is executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

In embodiments, aspects of the techniques described herein (e.g., timing the emission of optical signals, processing received return signals, generating point clouds, performing one or more (e.g., all) of the steps of the methods described herein, etc.) may be implemented using machine learning and/or artificial intelligence technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. A value of a feature may be a measurement of the corresponding property of an entity or an instance of information regarding an entity. Features can also have data types. For instance, a feature can have an image data type, a numerical data type, a text data type (e.g., a structured text data type or an unstructured (“free”) text data type), a categorical data type, or any other suitable data type. In general, a feature's data type is categorical if the set of values that can be assigned to the feature is finite.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

As used herein, “data analytics” may refer to the process of analyzing data (e.g., using machine learning models, artificial intelligence, models, or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

Data analytics tools are used to guide decision-making and/or to control systems in a wide variety of fields and industries, e.g., security; transportation; risk assessment and management; supply chain logistics; and energy management. The processes used to develop data analytics tools suitable for carrying out specific data analytics tasks generally include steps of data collection, data preparation, feature engineering, model generation, and/or model deployment.

As used herein, “spatial data” may refer to data relating to the location, shape, and/or geometry of one or more spatial objects. Data collected by lidar systems, devices, and chips described herein may be considered spatial data. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment). In some cases, a spatial object may be represented as a cluster of points in a 3-D point-cloud.

As used herein, “spatial attribute” may refer to an attribute of a spatial object that relates to the object's location, shape, or geometry. Spatial objects or observations may also have “non-spatial attributes.” For example, a residential lot is a spatial object that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

“Computer vision” generally refers to the use of computer systems to analyze and interpret image data. In some embodiments, computer vision may be used to analyze and interpret data collected by lidar systems (e.g., point-clouds). Computer vision tools generally use models that incorporate principles of geometry and/or physics. Such models may be trained to solve specific problems within the computer vision domain using machine learning techniques. For example, computer vision models may be trained to perform object recognition (recognizing instances of objects or object classes in images), identification (identifying an individual instance of an object in an image), detection (detecting specific types of objects or events in images), etc.

Computer vision tools (e.g., models, systems, etc.) may perform one or more of the following functions: image pre-processing, feature extraction, and detection/segmentation. Some examples of image pre-processing techniques include, without limitation, image re-sampling, noise reduction, contrast enhancement, and scaling (e.g., generating a scale space representation). Extracted features may be low-level (e.g., raw pixels, pixel intensities, pixel colors, gradients, patterns and textures (e.g., combinations of colors in close proximity), color histograms, motion vectors, edges, lines, corners, ridges, etc.), mid-level (e.g., shapes, surfaces, volumes, patterns, etc.), or high-level (e.g., objects, scenes, events, etc.). The detection/segmentation function may involve selection of a subset of the input image data (e.g., one or more images within a set of images, one or more regions within an image, etc.) for further processing.

### Some Embodiments

Some embodiments may include any of the following:

A1. A method of controlling a lidar device, the method including: determining a horizontal scan period P_{H} for a lidar device; determining a vertical swipe duration Dₛ for the lidar device based on (i) the horizontal scan period P_{H} and (ii) a target frame duration D_{f} for the lidar device; determining a dead time D_{d} for the lidar device based on the vertical swipe duration Dₛ, the horizontal scan period P_{H}, and the target frame duration D_{f}, and controlling the lidar device to scan an environment according to the vertical swipe duration Dₛ and the dead time D_{d}.

A2. The method of clause A1, wherein the target frame duration D_{f} corresponds to a frame rate of a sensor system associated with the lidar device.

A3. The method of A1, wherein the lidar device is configured to scan the surrounding environment by emitting optical signals, wherein each optical signal is emitted toward a location comprising a horizontal component and a vertical component, and wherein the horizontal component and the vertical component oscillate over successive optical signals.

A4. The method of clause A1, wherein the vertical swipe duration Dₛ is less than the target frame duration D_{f}.

A5. The method of clause A4, wherein the vertical swipe duration Dₛ is equal to

$${D}_{s} = {N}_{1} \frac{{P}_{H}}{2} ,$$

where N₁ is an integer greater than zero.

A6. The method of clause A1, wherein determining the vertical swipe duration Dₛ comprises: obtaining a first value by rounding D_{f}/(P_{H}/2) down to a nearest integer; obtaining a second value by subtracting N₂ from the first value, where N₂ is an integer greater than or equal to zero; and determining the vertical swipe duration Dₛ by multiplying the second value by (P_{H}/2).

A7. The method of clause A1, wherein the dead time D_{d} is equal to

$${D}_{d} = {N}_{3} \frac{{P}_{H}}{2} ,$$

where N₃ is an integer greater than zero.

A8. The method of clause A1, wherein controlling the lidar device comprises adjusting the dead time D_{d} over successive lidar scans.

A9. The method of clause A8, wherein a scan duration for the lidar device is equal to the vertical swipe duration Dₛ plus the dead time D_{d}, and wherein the dead time D_{d} is adjusted to make the scan duration consistent with the target frame duration D_{f}, on average, over successive lidar scans.

A10. A lidar system comprising: a lidar device; and at least one computer processor programmed to perform operations comprising: determining a horizontal scan period P_{H} for a lidar device; determining a vertical swipe duration Dₛ for the lidar device based on (i) the horizontal scan period P_{H} and (ii) a target frame duration D_{f} for the lidar device; determining a dead time D_{d} for the lidar device based on the vertical swipe duration Dₛ, the horizontal scan period P_{H}, and the target frame duration D_{f}, and controlling the lidar device to scan an environment according to the vertical swipe duration Dₛ and the dead time D_{d}.

A11. The lidar system of clause A10, wherein the target frame duration D_{f} corresponds to a frame rate of a sensor system associated with the lidar device.

A12. The lidar system of clause A10, wherein the lidar device is configured to scan the surrounding environment by emitting optical signals, wherein each optical signal is emitted toward a location comprising a horizontal component and a vertical component, and wherein the horizontal component and the vertical component oscillate over successive optical signals.

A13. The lidar system of clause A10, wherein the vertical swipe duration Dₛ is less than the target frame duration D_{f}.

A14. The lidar system of clause A13, wherein the vertical swipe duration Dₛ is equal to

$${D}_{s} = {N}_{1} \frac{{P}_{H}}{2} ,$$

where N₁ is an integer greater than zero.

A15. The lidar system of clause A10, wherein determining the vertical swipe duration Dₛ comprises: obtaining a first value by rounding D_{f}/(P_{H}/2) down to a nearest integer; obtaining a second value by subtracting N₂ from the first value, where N₂ is an integer greater than or equal to zero; and determining the vertical swipe duration Dₛ by multiplying the second value by (P_{H}/2).

A16. The lidar system of clause A10, wherein the dead time D_{d} is equal to

$${D}_{d} = {N}_{3} \frac{{P}_{H}}{2} ,$$

where Ns is an integer greater than zero.

A17. The lidar system of clause A10, wherein controlling the lidar device comprises adjusting the dead time D_{d} over successive lidar scans.

A18. The method of clause A17, wherein a scan duration for the lidar device is equal to the vertical swipe duration Dₛ plus the dead time Da, and wherein the dead time D_{d} is adjusted to make the scan duration consistent with the target frame duration D_{f}, on average, over successive lidar scans.

A19. A computer program product for controlling a lidar device, the computer program product comprising a non-transitory, computer-readable medium having computer readable program code stored thereon that, when executed by at least one computer processor, is configured to perform operations comprising: determining a horizontal scan period P_{H} for a lidar device; determining a vertical swipe duration Dₛ for the lidar device based on (i) the horizontal scan period P_{H} and (ii) a target frame duration D_{f} for the lidar device; determining a dead time Da for the lidar device based on the vertical swipe duration Dₛ, the horizontal scan period P_{H}, and the target frame duration D_{f}, and controlling the lidar device to scan an environment according to the vertical swipe duration Dₛ and the dead time D_{d}.

A20. The computer program product of clause A19, wherein the target frame duration D_{f} corresponds to a frame rate of a sensor system associated with the lidar device.

### Terminology

The phrasing and terminology used herein are for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of controlling a lidar device, the method comprising:
determining a horizontal scan period P_{H} for a lidar device;
determining a vertical swipe duration Dₛ for the lidar device based on (i) the horizontal scan period P_{H} and (ii) a target frame duration D_{f} for the lidar device;
determining a dead time D_{d} for the lidar device based on the vertical swipe duration Dₛ, the horizontal scan period P_{H}, and the target frame duration D_{f}, and
controlling the lidar device to scan an environment according to the vertical swipe duration Dₛ and the dead time D_{d}.

2. The method of claim 1, wherein the target frame duration D_{f} corresponds to a frame rate of a sensor system associated with the lidar device.

3. The method of claim 1, wherein the lidar device is configured to scan the surrounding environment by emitting optical signals, wherein each optical signal is emitted toward a location comprising a horizontal component and a vertical component, and wherein the horizontal component and the vertical component oscillate over successive optical signals.

4. The method of claim 1, wherein the vertical swipe duration Dₛ is less than the target frame duration D_{f}.

5. The method of claim 4, wherein the vertical swipe duration Dₛ is equal to
$${D}_{s} = {N}_{1} \frac{{P}_{H}}{2} ,$$
where N₁ is an integer greater than zero.

6. The method of claim 1, wherein determining the vertical swipe duration Dₛ comprises:
obtaining a first value by rounding D_{f}/(P_{H}/2) down to a nearest integer;
obtaining a second value by subtracting N₂ from the first value, where N₂ is an integer greater than or equal to zero; and
determining the vertical swipe duration Dₛ by multiplying the second value by (P_{H}/2).

7. The method of claim 1, wherein the dead time D_{d} is equal to
$${D}_{d} = {N}_{3} \frac{{P}_{H}}{2} ,$$
where N₃ is an integer greater than zero.

8. The method of claim 1, wherein controlling the lidar device comprises adjusting the dead time D_{d} over successive lidar scans.

9. The method of claim 8, wherein a scan duration for the lidar device is equal to the vertical swipe duration Dₛ plus the dead time D_{d}, and wherein the dead time D_{d} is adjusted to make the scan duration consistent with the target frame duration D_{f}, on average, over successive lidar scans.

10. A lidar system comprising:
a lidar device; and
at least one computer processor programmed to perform operations comprising:
determining a horizontal scan period P_{H} for a lidar device;
determining a vertical swipe duration Dₛ for the lidar device based on (i) the horizontal scan period P_{H} and (ii) a target frame duration D_{f} for the lidar device;
determining a dead time D_{d} for the lidar device based on the vertical swipe duration Dₛ, the horizontal scan period P_{H}, and the target frame duration D_{f}, and
controlling the lidar device to scan an environment according to the vertical swipe duration Dₛ and the dead time D_{d}.

11. The lidar system of claim 10, wherein the target frame duration D_{f} corresponds to a frame rate of a sensor system associated with the lidar device.

12. The lidar system of claim 10, wherein the lidar device is configured to scan the surrounding environment by emitting optical signals, wherein each optical signal is emitted toward a location comprising a horizontal component and a vertical component, and wherein the horizontal component and the vertical component oscillate over successive optical signals.

13. The lidar system of claim 10, wherein the vertical swipe duration Dₛ is less than the target frame duration D_{f}.

14. The lidar system of claim 13, wherein the vertical swipe duration Dₛ is equal to
$${D}_{s} = {N}_{1} \frac{{P}_{H}}{2} ,$$
where N₁ is an integer greater than zero.

15. The lidar system of claim 10, wherein determining the vertical swipe duration Dₛ comprises:
obtaining a first value by rounding D_{f}/(P_{H}/2) down to a nearest integer;
obtaining a second value by subtracting N₂ from the first value, where N₂ is an integer greater than or equal to zero; and
determining the vertical swipe duration Dₛ by multiplying the second value by (P_{H}/2).

16. The lidar system of claim 10, wherein the dead time D_{d} is equal to
$${D}_{d} = {N}_{3} \frac{{P}_{H}}{2} ,$$
where N₃ is an integer greater than zero.

17. The lidar system of claim 10, wherein controlling the lidar device comprises adjusting the dead time D_{d} over successive lidar scans.

18. The lidar system of claim 17, wherein a scan duration for the lidar device is equal to the vertical swipe duration Dₛ plus the dead time D_{d}, and wherein the dead time D_{d} is adjusted to make the scan duration consistent with the target frame duration D_{f}, on average, over successive lidar scans.

19. A computer program product for controlling a lidar device, the computer program product comprising a non-transitory, computer-readable medium having computer readable program code stored thereon that, when executed by at least one computer processor, is configured to perform operations comprising:
determining a horizontal scan period PH for a lidar device;
determining a vertical swipe duration Dₛ for the lidar device based on (i) the horizontal scan period P_{H} and (ii) a target frame duration D_{f} for the lidar device;
determining a dead time D_{d} for the lidar device based on the vertical swipe duration Dₛ, the horizontal scan period PH, and the target frame duration D_{f}, and
controlling the lidar device to scan an environment according to the vertical swipe duration Dₛ and the dead time D_{d}.

20. The computer program product of claim 19, wherein the target frame duration D_{f} corresponds to a frame rate of a sensor system associated with the lidar device.
